(19) United States
(12) Patent Application Publication
(10) Pub. No.: US 2026/0326479 A1
(43) Pub. Date: Oct. 22, 2026

(54) Portable Art Palette and Method

(71) Applicant: Jerry's Artarama N.C., Inc., Raleigh, NC (US)

(72) Inventor: Heather Bankston, Raleigh, NC (US)

(73) Assignee: Jerry's Artarama N.C., Inc., Raleigh, NC (US)

(21) Appl. No.: 19/644,345

(22) Filed: Apr. 10, 2026

Related U.S. Application Data
(60) Provisional application No. 63/789,653, filed on Apr. 16, 2025.

(51) Int. Cl. B44D 3/02

(52) U.S. Cl. CPC B44D 3/02

(57) ABSTRACT

A portable art palette. The portable art palette may include a plate body defining an upper surface and a lower surface; a notch formed along an edge of the plate body; a mixing tray region defined in a portion of the upper surface of the plate body, the mixing tray region providing a paint mixing surface; one or more clips mounted to the plate body and configured to releasably hold a painting/drawing surface on the upper surface of the plate body; and at least one attachment site on the plate body configured to receive at least one attachment in a pivoting fashion.

### RELATED APPLICATIONS

This application is related and claims priority to U.S. Provisional Patent Application No.: 63/789,653, filed on Apr. 16, 2025, the application of which is incorporate herein by reference in its entirety.

### TECHNICAL FIELD

The subject matter relates generally to equipment for art painting and more particularly to a portable art palette and method.

### BACKGROUND

Plein air painting is the practice of painting outdoors with the subject in full view. The term comes from the French phrase “en plein air,” which means “in the open air.” Plein air artists capture the essence of a subject by incorporating natural light, color, and movement into their work. They rely more on direct observation of colors than on interpretive color, which is used in studio painting.

Today, plein air painting is a flourishing trend in our art world. However, standing outdoors in the middle of a beautiful scene with an easel set up and brush in hand can be challenging to the artist. One aspect of plein air painting is that good equipment is needed. For example, equipment is needed that lends well to organizing the plein air artist's paint supplies. Further, an important consideration for an easel for plein air painting is weight. For example, the easel needs to be lightweight because it may have to be carried for long distances. Further, the easel needs to be comfortable to use in either a standing or sitting position.

### SUMMARY

In one embodiment, a portable art palette is provided. The portable art palette may include a plate body defining an upper surface and a lower surface; a notch formed along an edge of the plate body; a mixing tray region defined in a portion of the upper surface of the plate body, the mixing tray region providing a paint mixing surface; one or more clips mounted to the plate body and configured to releasably hold a painting/drawing surface on the upper surface of the plate body; and at least one attachment site on the plate body configured to receive at least one attachment in a pivoting fashion. The plate body may include a top plate aligned atop a bottom plate, the top plate and the bottom plate having substantially the same footprint, and wherein the top plate may include a mixing tray opening, and wherein an exposed surface of the bottom plate through the mixing tray opening of the top plate provides the paint mixing surface bounded by edges of the mixing tray opening. The portable art palette may further include one or more magnets arranged below the upper surface of the plate body, the one or more magnets configured to hold a magnetically responsive item on the upper surface of the plate body. The portable art palette may further include one or more magnets arranged below the top plate, wherein the one or more magnets may be positioned within one or more corresponding cutouts formed in the bottom plate, the one or more magnets configured to hold a magnetically responsive item on the upper surface of the plate body. The portable art palette may further include one or more elastic cords arranged on the upper surface of the plate body and secured thereto, the one or more elastic cords configured to hold any of an art utensil, a paper towel, and/or a sponge. The portable art palette may further include one or more openings disposed in the plate body, the one or more openings configurable to accommodate one or more art utensils comprising any one or more of a paint brush, a pencil, a marker, and/or an art utensil. The portable art palette may further include one or more slotted grommets mounted in the one or more openings of the plate body, the one or more slotted grommets configured to hold the one or more art utensils. The at least one attachment may include one or more paddle attachments. The one or more paddle attachments may include any one or more of a cup holder paddle having a cup-sized opening, a brush holder paddle having a plurality of circular openings of various diameters, and/or a mixing tray paddle having a recessed region for receiving and mixing paint. The one or more paddle attachments may include a plurality of paddle attachments and are installed at a common attachment site in a stacked, pivoting arrangement. The portable art palette may further include a handle mounted on the lower surface of the plate body, the handle configured to be grasped by a user's hand. The handle may be positioned at about a middle region of the lower surface of the plate body. The portable art palette may further include an elastic band spanning a lower portion of the plate body, the elastic band at least partially overlapping with the notch. The portable art palette may further include support arms spaced apart from one another and pivotally coupled to the lower surface of the plate body. The support arms may be configurable to help support a painting/drawing surface or easel attachment attached to the plate body.

In another embodiment, an easel attachment is provided. The easel attachment may include a support structure configured to support a painting/drawing surface; a tripod plate mounted on an underside of the support structure, the tripod plate configured for mounting the easel attachment to a tripod; at least one paddle attachment pivotally coupled to the support structure; and wherein the support structure is configured to receive an art palette in a coupled arrangement. The easel attachment may further include an elastic cord arranged on the support structure, the elastic cord configured to hold down a lower edge of a painting surface positioned on the easel attachment. The at least one paddle attachment may include one or more of a cup holder paddle having a cup-sized opening, a brush holder paddle having a plurality of circular openings of various diameters, and/or a mixing tray paddle having a recessed region for receiving and mixing paint. The at least one paddle attachment may include a plurality of paddle attachments, wherein one or more of the plurality of paddle attachments are coupled to opposing sides of the support structure from another one or more of the plurality of paddle attachments. The support structure may include a top plate aligned atop a bottom support. The support structure may include a top plate, one or more support plates, and a bottom plate, wherein the one or more support plates are disposed between the top plate and the bottom plate.

In another embodiment, a portable art palette system is provided. The may include an art palette, including a plate body defining an upper surface and a lower surface; a notch formed along an edge of the plate body; a mixing tray region defined in a portion of the upper surface of the plate body, the mixing tray region providing a paint mixing surface; one or more clips mounted to the plate body and configured to releasably hold a painting/drawing surface on the upper surface of the plate body; and at least one attachment site on the plate body configured to receive at least one paddle attachment in a pivoting fashion. The portable art palette system may further include an easel attachment configured to be coupled to the art palette, the easel attachment including a support structure configured to support a painting/drawing surface; a tripod plate mounted on an underside of the support structure, the tripod plate configured for mounting the easel attachment to a tripod; and at least one paddle attachment pivotally coupled to the support structure.

### BRIEF DESCRIPTION OF THE DRAWINGS

Having thus described the subject matter in general terms, reference will now be made to the accompanying drawings, which are not necessarily drawn to scale, and wherein:

FIG. 1 illustrates a perspective view of an example of an art palette in use, in accordance with an embodiment of the invention;

FIG. 2 illustrates a perspective view of the art palette shown in use in FIG. 1 but absent the sketchbook or notebook, in accordance with an embodiment of the invention;

FIG. 3 and FIG. 4 illustrate a top perspective view and a bottom perspective view, respectively, of the art palette shown in FIG. 1 and FIG. 2, in accordance with an embodiment of the invention;

FIG. 5 illustrates perspective views of examples of paddle attachments of the art palette shown in FIG. 1 through FIG. 4, in accordance with an embodiment of the invention;

FIG. 6, FIG. 7, and FIG. 8 illustrate an exploded view, a top plan view, and a bottom plan view, respectively, of the art palette shown in FIG. 1 through FIG. 4, in accordance with an embodiment of the invention;

FIG. 9 illustrates side views and end views of the art palette shown in FIG. 1 through FIG. 8, in accordance with an embodiment of the invention;

FIG. 10 and FIG. 11 illustrate a top perspective view and a bottom perspective view, respectively, of an easel attachment for use with the art palette shown in FIG. 1 through FIG. 9, in accordance with an embodiment of the invention;

FIG. 12 and FIG. 13 illustrate a top exploded view and a bottom exploded view, respectively, of the easel attachment shown in FIG. 10 and FIG. 11, in accordance with an embodiment of the invention;

FIG. 14 and FIG. 15 illustrate a top plan view and a bottom plan view, respectively, of the easel attachment shown in FIG. 10 and FIG. 11, in accordance with an embodiment of the invention;

FIG. 16 illustrates side views and end views of the easel attachment shown in FIG. 10 and FIG. 11, in accordance with an embodiment of the invention;

FIG. 17 and FIG. 18 illustrate a top perspective view and a bottom perspective view, respectively, of an example of the art palette shown in FIG. 1 through FIG. 9 and the easel attachment shown in FIG. 10 through FIG. 16 in use together, in accordance with an embodiment of the invention;

FIG. 19 and FIG. 20 illustrate a top plan view and a bottom plan view, respectively, of an example of the art palette shown in FIG. 1 through FIG. 9 and the easel attachment shown in FIG. 10 through FIG. 16 in use together, in accordance with an embodiment of the invention;

FIG. 21 and FIG. 22 illustrate a top plan view and a bottom plan view, respectively, of an art palette, in accordance with another embodiment of the invention;

FIG. 23 and FIG. 24 illustrate a top plan view and a bottom plan view, respectively, of an easel attachment for use with the art palette shown in FIG. 21 and FIG. 22, in accordance with another embodiment of the invention;

FIG. 25 and FIG. 26 illustrate a top plan view and a bottom plan view, respectively, of an example of the art palette shown in FIG. 21 and FIG. 22 and the easel attachment shown in FIG. 23 and FIG. 24 in use together, in accordance with another embodiment of the invention;

FIG. 27 illustrates a perspective view of an example of the art palette and easel attachment shown in FIG. 25 and FIG. 26 mounted atop a standard tripod, in accordance with an embodiment of the invention;

FIG. 28 and FIG. 29 illustrate a top perspective view and a bottom perspective view, respectively, of the art palette, in accordance with yet another embodiment of the invention;

FIG. 30, FIG. 31, and FIG. 32 illustrate an exploded view, a top plan view, and a bottom plan view, respectively, of the art palette shown in FIG. 28 and FIG. 29, in accordance with yet another embodiment of the invention;

FIG. 33 illustrates side views and end views of the art palette shown in FIG. 28 through FIG. 32, in accordance with yet another embodiment of the invention;

FIG. 34 and FIG. 35 illustrate a top perspective view and a bottom perspective view, respectively, of an easel attachment for use with the art palette shown in FIG. 28 through FIG. 33, in accordance with yet another embodiment of the invention;

FIG. 36 illustrates a top exploded view of the easel attachment shown in FIG. 34 and FIG. 35, in accordance with yet another embodiment of the invention;

FIG. 37 illustrates top plan views of the four plates forming the easel attachment shown in FIG. 36, in accordance with yet another embodiment of the invention;

FIG. 38 and FIG. 39 illustrate a top plan view and a bottom plan view, respectively, of the easel attachment shown in FIG. 34 and FIG. 35, in accordance with yet another embodiment of the invention;

FIG. 40 illustrates side views and end views of the easel attachment shown in FIG. 34 through FIG. 39, in accordance with yet another embodiment of the invention;

FIG. 41 and FIG. 42 illustrate a top perspective view and a bottom perspective view, respectively, of an example of the art palette shown in FIG. 28 through FIG. 33 and the easel attachment shown in FIG. 34 through FIG. 40 in use together, in accordance with yet another embodiment of the invention;

FIG. 43 and FIG. 44 illustrate a top plan view and a bottom plan view, respectively, of an example of the art palette shown in FIG. 28 through FIG. 33 and the easel attachment shown in FIG. 34 through FIG. 40 in use together, in accordance with yet another embodiment of the invention;

FIG. 45, FIG. 46, FIG. 47, and FIG. 48 show an example of the art palette and the easel attachment in use, in accordance with an embodiment of the invention;

FIG. 49 illustrates a flow diagram of an example of a method of using the art palette as a handheld plein air workspace, in accordance with an embodiment of the invention;

FIG. 50 illustrates a flow diagram of an example of a method of using the art palette and the easel attachment as a hands-free plein air workspace, in accordance with an embodiment of the invention; and

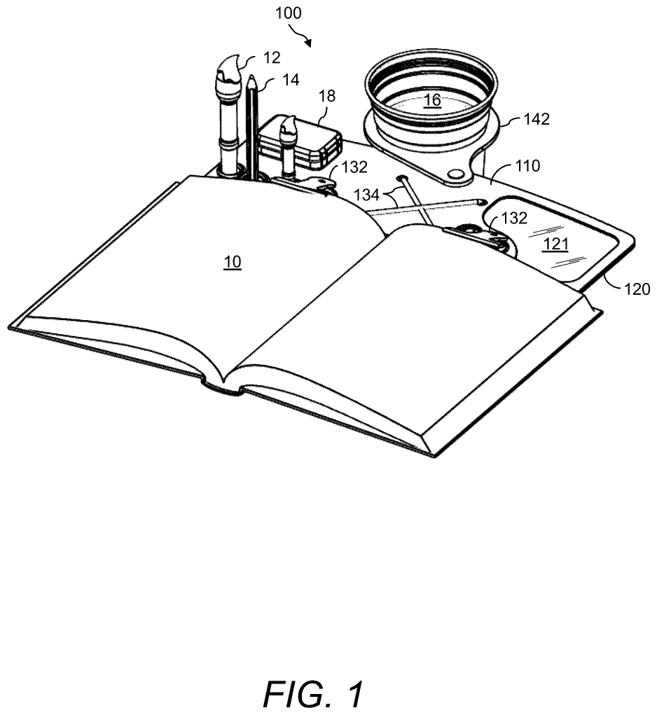

FIGS. 1-94 in Appendix 1 (incorporated herein in its entirety) illustrate various example views of the portable art palette and example components and attachments, in accordance with embodiments of the invention.

### DETAILED DESCRIPTION

The subject matter now will be described more fully hereinafter with reference to the accompanying drawings, in which some, but not all embodiments of the subject matter are shown. Like numbers refer to like elements throughout. The subject matter may be embodied in many different forms and should not be construed as limited to the embodiments set forth herein; rather, these embodiments are provided so that this disclosure will satisfy applicable legal requirements. Indeed, many modifications and other embodiments of the subject matter set forth herein will come to mind to one skilled in the art to which the subject matter pertains having the benefit of the teachings presented in the foregoing descriptions and the associated drawings. Therefore, it is to be understood that the subject matter is not to be limited to the specific embodiments disclosed and that modifications and other embodiments are intended to be included within the scope of the appended claims.

In some embodiments, the subject matter provides a portable art palette and method. Further, in some embodiments, the portable art palette and method may be used in combination with an easel attachment that can be fastened to a standard tripod.

In some embodiments, the portable art palette and method provide a handheld plein air watercolor workspace for supporting any painting/drawing surface, such as, but not limited to, a sketchbook, an art book, a notebook, a small canvas panel, and/or the like.

In some embodiments, the portable art palette and method provide a portable art palette formed of plastic (e.g., white plastic) such that the entire workspace surface can be used as a palette.

In some embodiments, the portable art palette and method provide a workspace that may include various features, such as, but not limited to, one or more cup holders, one or more brush and/or pencil holders, one or more paper towel holders, one or more sponge holders, one or more other art utensil holders, one or more magnets for holding metal tins and/or half pans, one or more clips for holding any painting/drawing surface, one or more paint mixing surfaces, and any combinations thereof.

In some embodiments, the portable art palette and method provide a workspace that may include one or more paddle attachments that are configurable, such as, but not limited to, one or more cup holder paddles, one or more brush or pencil holder paddles, and one or more mixing tray paddles that are configurable.

In some embodiments, the portable art palette and method provide a workspace in combination with an easel attachment that can be fastened to a standard tripod for providing a hands-free plein air workspace.

In some embodiments, the portable art palette and method provide a hands-free workspace in combination with an easel attachment and wherein the easel attachment may include one or more paddle attachments that are configurable, such as, but not limited to, one or more cup holder paddles, one or more brush or pencil holder paddles, and one or more mixing tray paddles that are configurable.

Further, a method of using the art palette as a handheld workspace is provided.

Further, a method of using the art palette and the easel attachment as a hands-free workspace is provided.

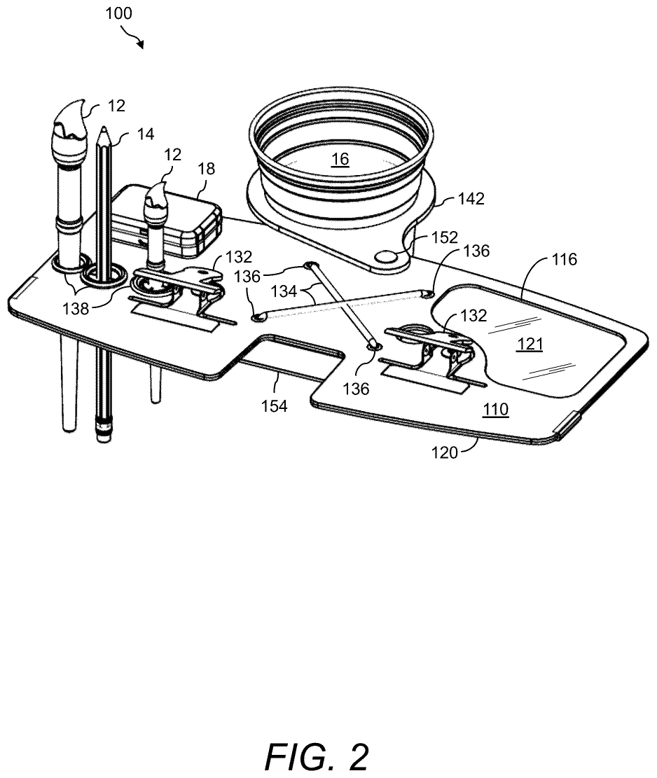

Referring now to FIG. 1 is a perspective view of an example of an art palette 100 in use, in accordance with an embodiment of the invention. The art palette 100 may provide a portable workspace (e.g., a portable handheld watercolor workspace) for painting (e.g., plein air painting) that can be clipped to any painting/drawing surface, such as, but not limited to, a sketchbook, an art book, a notebook, a small canvas panel, and/or the like. For example, FIG. 1 shows an example art palette 100 holding a sketchbook 10. FIG. 1 also shows the art palette 100 equipped with certain paint (e.g., watercolor) utensils, such as brushes 12, pencils 14, a plastic cup 16, and a metal watercolor tin or half pan 18. Further to the example, FIG. 2 is a perspective view of the example art palette 100 shown in use in FIG. 1 but absent the sketchbook 10 and showing other features thereof.

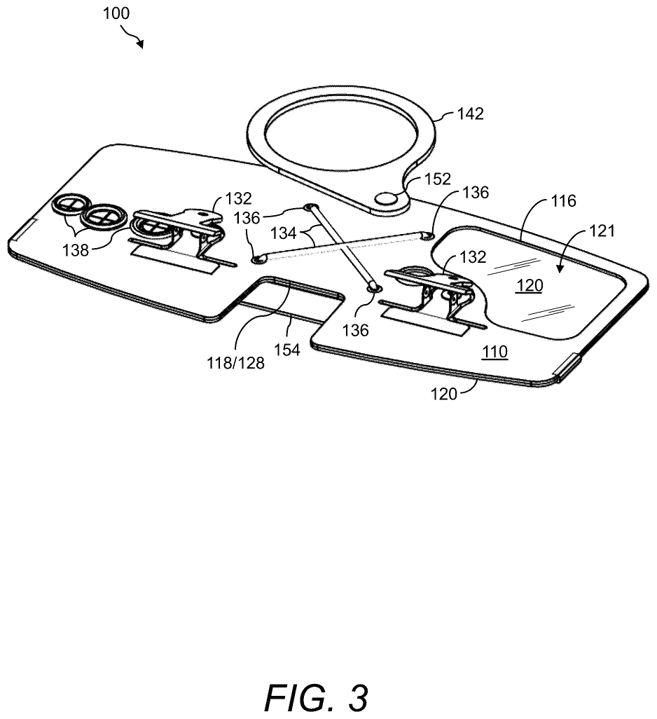

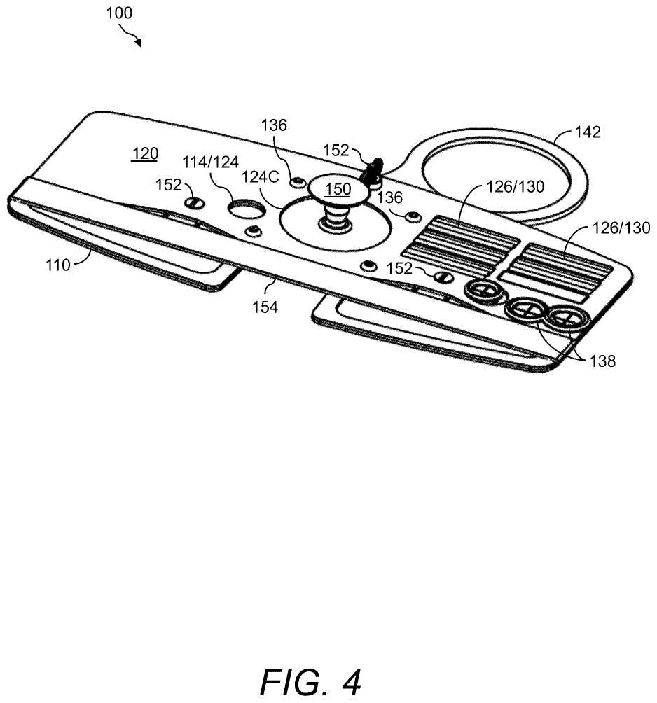

Referring now to FIG. 3 and FIG. 4 is a top perspective view and a bottom perspective view, respectively, of the art palette 100 shown in FIG. 1 and FIG. 2, in accordance with an embodiment of the invention.

Referring still to FIG. 1, FIG. 2, FIG. 3, and FIG. 4, the art palette 100 may include a top plate 110 aligned atop a bottom plate 120. The top plate 110 and the bottom plate 120 may have substantially the same footprint. The top plate 110 may have a notch 118 and the bottom plate 120 may have a corresponding notch 128. The notches 118, 128 may provide clearance for receiving the binder of, for example, the sketchbook 10. The top plate 110 may include a mixing tray opening 116 such that a mixing tray region 121 may be formed with the top plate 110 atop the bottom plate 120. That is the exposed surface of the bottom plate 120 through the mixing tray opening 116 of the top plate 110 may provide a mixing surface bounded by the edges of the mixing tray opening 116.

The art palette 100 is not limited to a two-piece structure including the top plate 110 and the bottom plate 120. This is exemplary only. In another example, the art palette 100 may be formed of one piece or layer of molded/formed plastic.

Additionally, the art palette 100 may include a set of magnets 130 arranged between the top plate 110 and the bottom plate 120, or below the top plate 110. The magnets 130 may be provided for holding any container that is magnetically responsive, such as the metal watercolor tin or half pan 18.

Additionally, the art palette 100 may include one or more clips 132 for holding any painting/drawing surface, such as, but not limited to, a sketchbook, an art book, a notebook, a small canvas panel, and/or the like. In this example, the art palette 100 may include two spring-loaded clips 132 to hold the sketchbook 10 and with the binding of the sketchbook 10 fitted into the notches 118, 128 of top plate 110 and bottom plate 120, respectively. The presence of two clips 132 allows for holding pages in place and ease of page turning.

Additionally, one or more elastic cords 134 may be arranged at about the center portion of the art palette 100. In this example, the art palette 100 may include two elastic cords 134 arranged in crisscross fashion (or other suitable fashion). The two elastic cords 134 may be provided, for example, to hold a paper towel, a sponge, or any other additional art utensils. In this example, each of the elastic cords 134 may be fastened to the art palette 100 using a thru-hole grommet 136 at each end, e.g., rubber thru-hole grommets 136.

Additionally, the art palette 100 may include one or more grommets, e.g., rubber slotted grommets 138. The slotted grommets 138 may be provided, for example, to hold art utensils, such as, but not limited to, paint brushes 12 and pencils 14. The art palette 100 may include an arrangement of slotted grommets 138 on one or both sides.

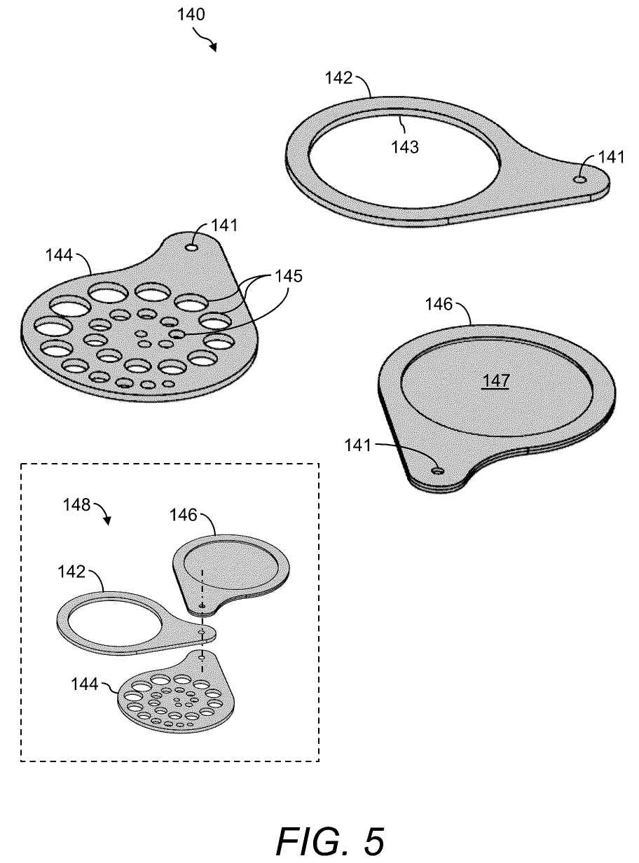

Additionally, the art palette 100 may include attachment sites for one or more paddle attachments 140. In one example, the art palette 100 may include a top center attachment site or pivot point for attaching a paddle attachment 140. The paddle attachment 140 may be rotated from one side to the other depending on artist preference. By way of example, FIG. 5 shows perspective views of example paddle attachments 140 of the art palette 100 shown in FIG. 1 through FIG. 4. Example paddle attachments 140 may include, but are not limited to, any one or more of a cup holder paddle 142, a brush holder paddle 144, a mixing tray paddle 146, and/or the like.

In one example, each of the paddle attachments 140 (e.g., 142, 144, 146) may include an attachment point 141. Further, the cup holder paddle 142 may include a cup-sized opening 143. The brush holder paddle 144 may include any number and arrangement of circular openings 145 of various diameters. The mixing tray paddle 146 may include a recessed region 147 for holding and mixing paint.

Further, any attachment site for paddle attachments 140 is not limited to one paddle attachment 140 only. One or more paddle attachments 140 may be installed at any attachment site. For example, FIG. 5 shows a paddle arrangement 148 that includes multiple paddle attachments 140, e.g., a cup holder paddle 142, a brush holder paddle 144, and a mixing tray paddle 146. That is, multiple paddle attachments 140 may be installed in pivoting fashion using one common attachment point.

Further, while the art palette 100 shown in FIG. 1 through FIG. 4 shows one attachment point only, the art palette 100 is not limited to one attachment point only. For example, the art palette 100 may include multiple attachment points, e.g., one attachment point at the top, another at the right side (not shown), and another at the left side (not shown), or other arrangement.

Additionally, the underside of the art palette 100 may include a handle (knob, ring, or the like) 150 by which a user may more easily grasp and hold the art palette 100 when in use. The handle 150 may be formed, for example, of rubber, plastic, or metal. The handle 150 may be arranged, for example, with respect to a large circular opening 124 at a center portion of the bottom plate 120; hereafter called circular opening 124C. The handle 150 may have a small end and a large end. In one example, the small end of the handle 150 may pass through circular opening 124C of bottom plate 120 and be adhered to the underside of the top plate 110. Alternatively, there may be no circular opening 124C, and the handle 150 may be adhered to the underside of the bottom plate 120. Or in an embodiment where the art palette 100 is a single molded top plate 110 the handle 150 may be adhered directly to the underside of the plate 110.

Additionally, the art palette 100 may include various types of fasteners 152 as needed for holding any components thereof. Types of fasteners 152 may include, but are not limited to, screws, bolts, hex nuts, wing nuts, washers, plastic push-in fasteners or clips, and/or the like. For example, a bolt and wing nut may be the fastener 152 that holds paddle attachments 140 and allows easy attachment and detachment for configuring the paddle attachments 140.

Additionally, in one embodiment the art palette 100 may include an elastic band 154 that spans the lower portion thereof, as shown in FIG. 3 and FIG. 4. The elastic band 154 may be used to help support the binder of the sketchbook 10. In this way, the elastic band 154 helps hold up the cover of the sketchbook 10.

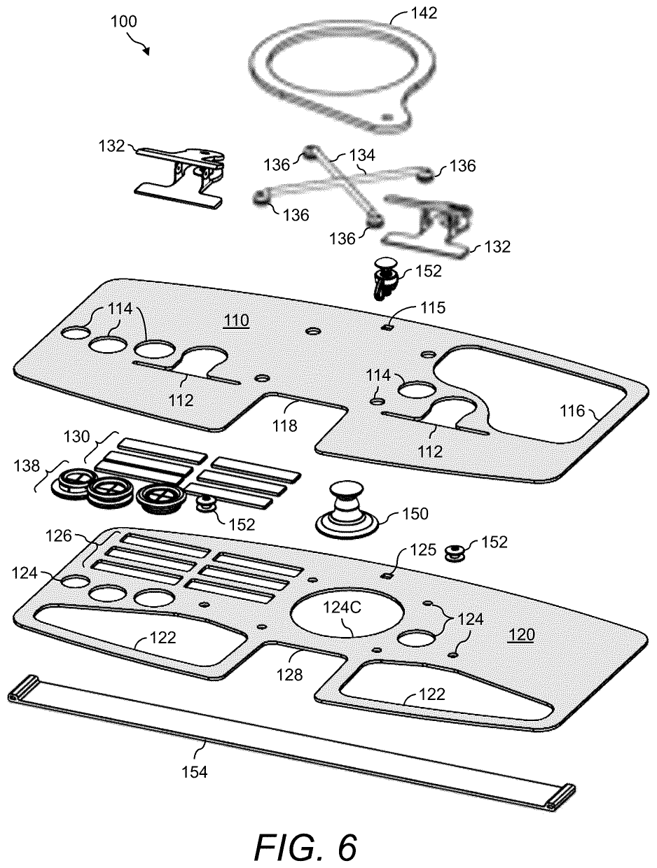

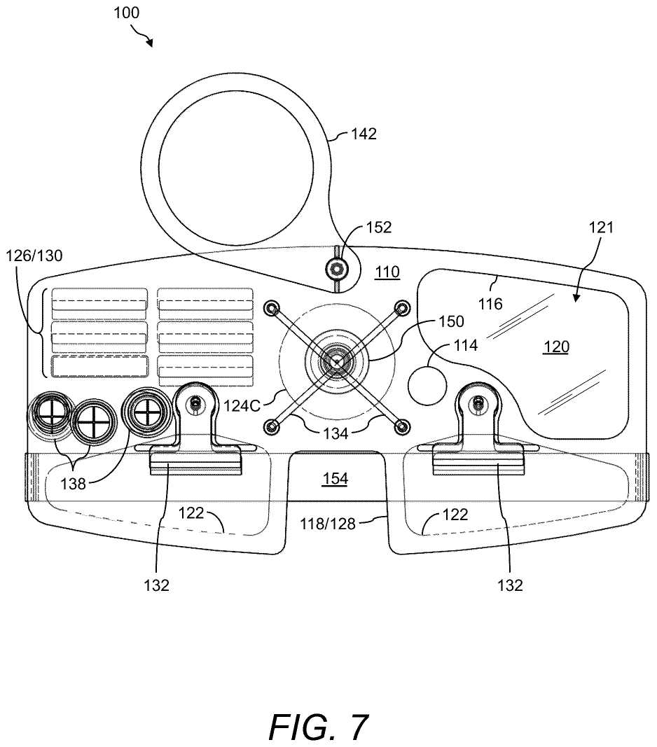

Referring now to FIG. 6, FIG. 7, and FIG. 8 is an exploded view, a top plan view, and a bottom plan view, respectively, of the example art palette 100 shown in FIG. 1 through FIG. 4, in accordance with an embodiment of the invention. In particular, FIG. 6 shows that the top plate 110 may include two clip clearance openings 112 for accommodating the two clips 132. Further, the top plate 110 may include an arrangement of circular openings 114 for installing, for example, the thru-hole grommets 136 and/or the slotted grommets 138. Further, the top plate 110 may include one or more paddle attachment openings 115 for installing one or more paddle attachments 140. Further, the top plate 110 may include the mixing tray opening 116 for forming the mixing tray region 121 (see FIG. 2 and FIG. 3).

Similarly, FIG. 6 shows that the bottom plate 120 may include two clip clearance openings 122 for accommodating the two clips 132. Further, the bottom plate 120 may include an arrangement of circular openings 124 for installing, for example, the thru-hole grommets 136 and/or the slotted grommets 138. Further, the bottom plate 120 may include one or more paddle attachment openings 125 for installing one or more paddle attachments 140. Additionally, FIG. 6 shows that the art palette 100 may include openings for magnets 130. The bottom plate 120 may include one or more magnet openings 126. In one example, magnets 130 may be adhered to the underside of the top plate 110. Then, the magnet openings 126 allow clearance space for the magnets 130 and therefore allow the top plate 110 and the bottom plate 120 to be fitted together with the magnets 130 present.

Referring still to FIG. 6, FIG. 7, and FIG. 8, while the circular opening 114/124 near the mixing tray region 121 is shown empty, optionally it may hold an additional slotted grommet 138 (not shown) for holding other art utensils.

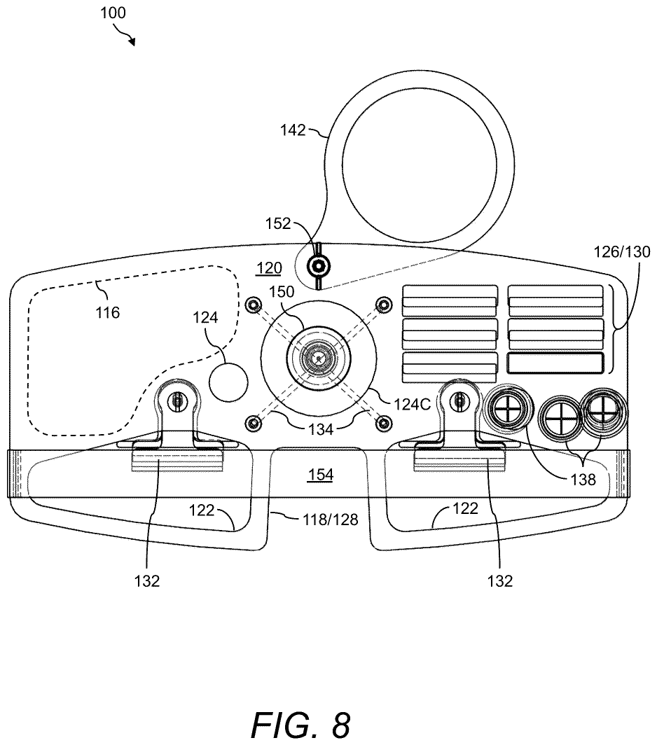

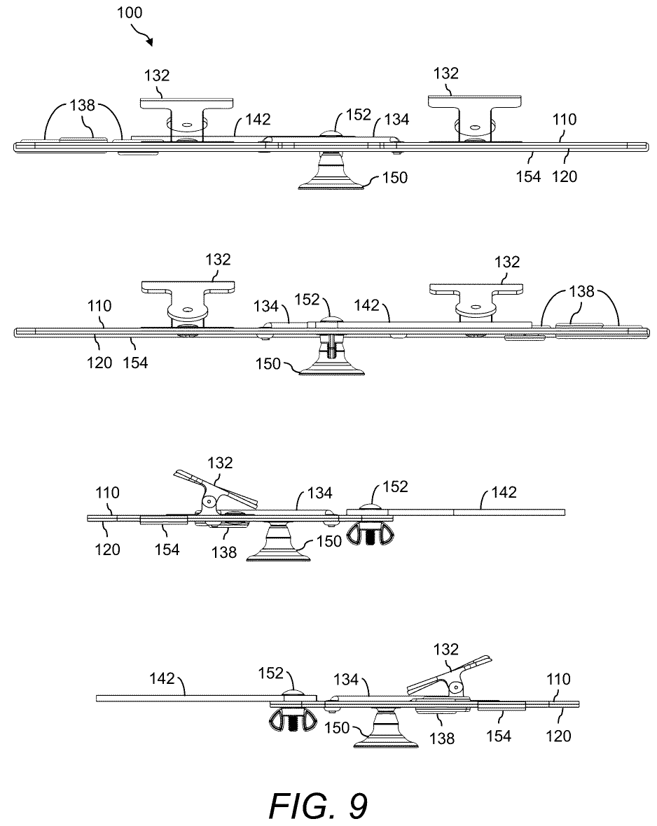

Referring now to FIG. 9 is side views and end views of the art palette 100 shown in FIG. 1 through FIG. 8, in accordance with an example embodiment of the invention.

Referring now again to FIG. 1 through FIG. 9, the top plate 110, the bottom plate 120, and the paddle attachments 140 of the art palette 100 may be formed of lightweight material, such as, but not limited to, molded plastic, aluminum, or the like. In one example, the top plate 110, the bottom plate 120, and the paddle attachments 140 of the art palette 100 may be formed of white plastic such that the entire workspace surface can be used as a palette because of the characteristics of the white plastic. For example, the mixing tray region 121 of the art palette 100 and the recessed region 147 of the mixing tray paddle 146 may be used as a palette because of the characteristics of the white plastic.

The size of the art palette 100 may vary. The overall width of the top plate 110 and the bottom plate 120 of the art palette 100 may be in the range of about 8 inches to about 14 inches in one non-limiting example. Further, the overall height of the top plate 110 and the bottom plate 120 may be in the range of about 4 inches to about 8 inches in one non-limiting example. Further, in one non-limiting example the thickness of the top plate 110 and the bottom plate 120 may each be about 0.0625 inches.

Similarly, the size of the paddle attachments 140 may vary. The overall diameter of the paddle attachments 140 may be in the range of about 2.5 inches to about 4.5 inches in one non-limiting example. Further, in one non-limiting example the thickness of the paddle attachments 140 may be about 0.125 inches.

Further, the notch 118 of top plate 110 and the notch 128 of the bottom plate 120 may be sized to accommodate the binding of a typical sketch or art book. In one non-limiting example, the notches 118, 128 may have a width of about 2 inches and a depth of about 2.5 inches.

Referring now again to FIG. 1 through FIG. 9, used alone the art palette 100 may provide a handheld workspace, e.g., handheld plein air workspace.

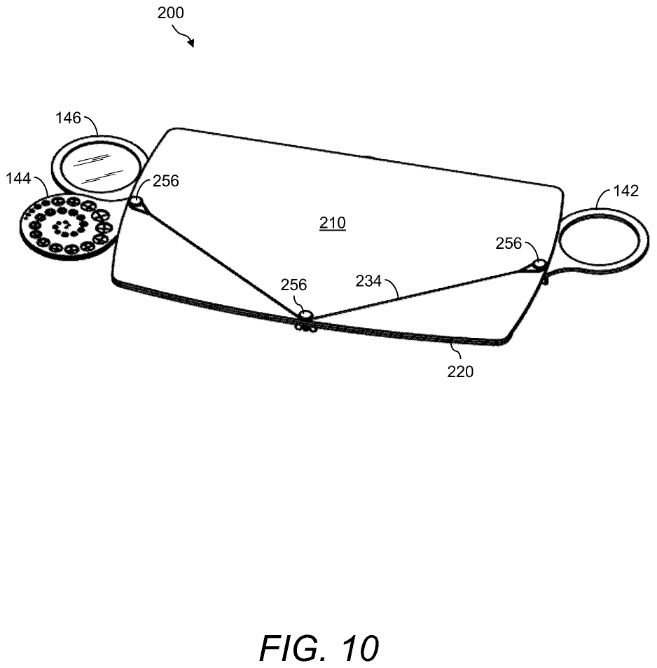

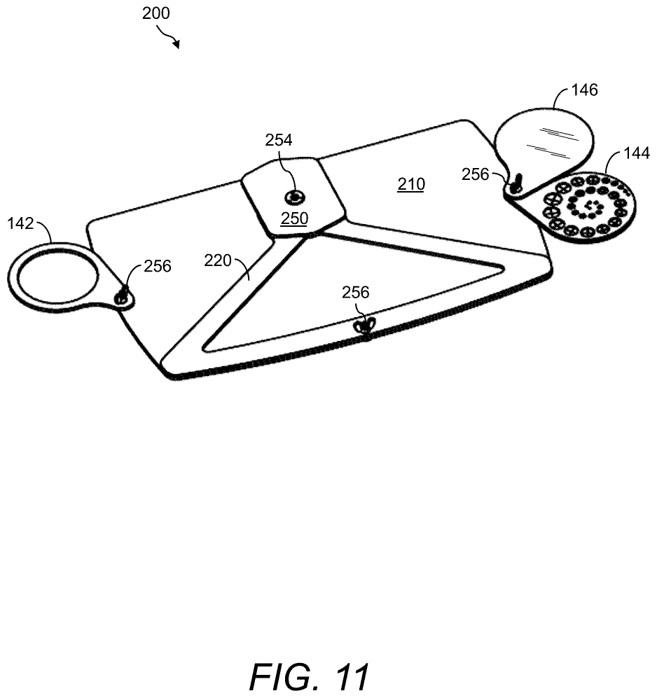

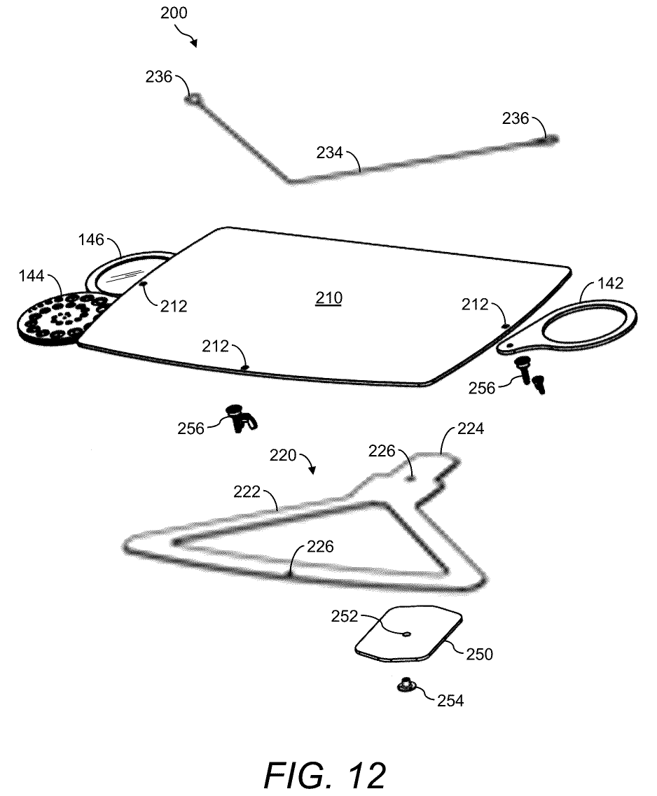

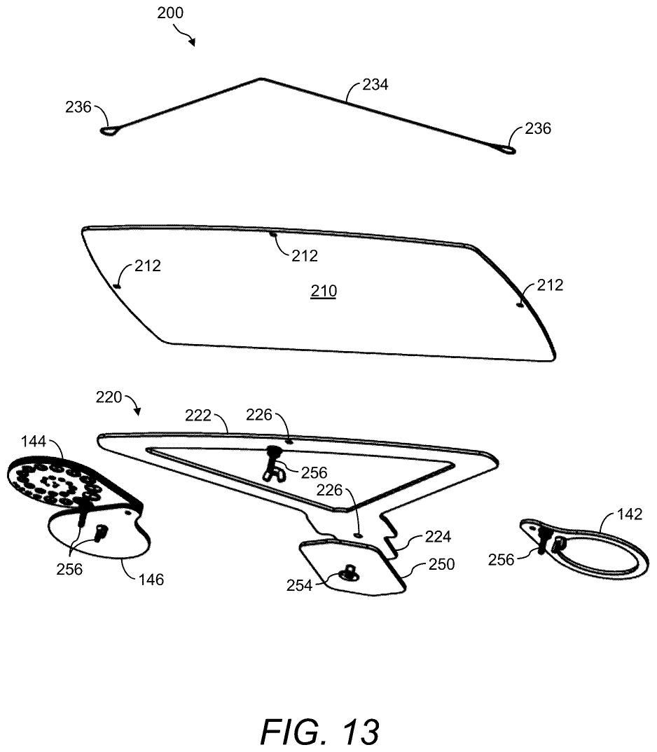

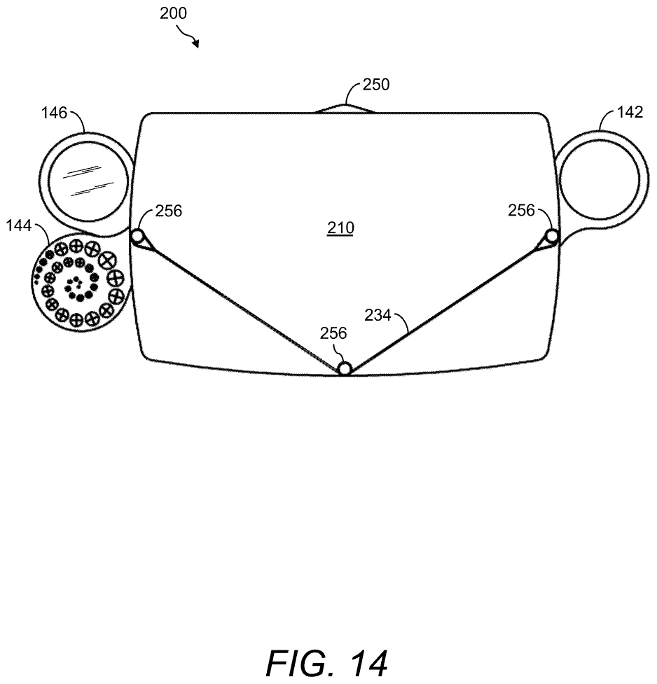

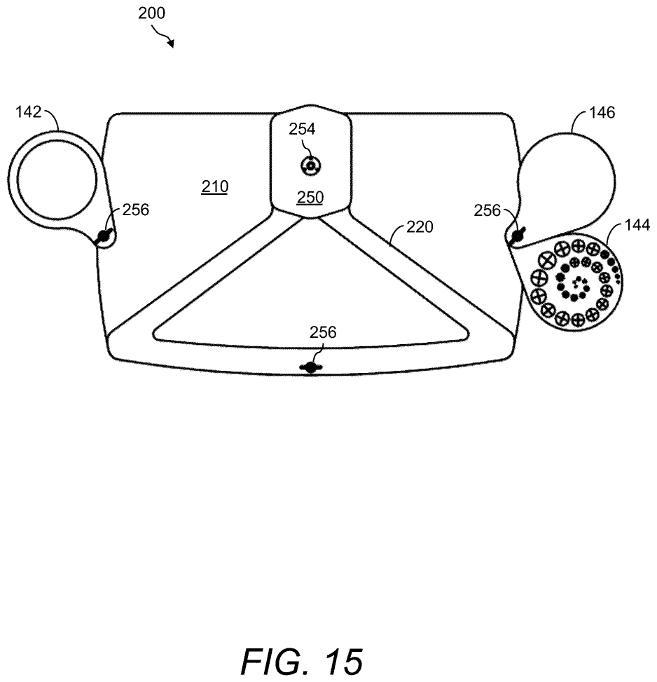

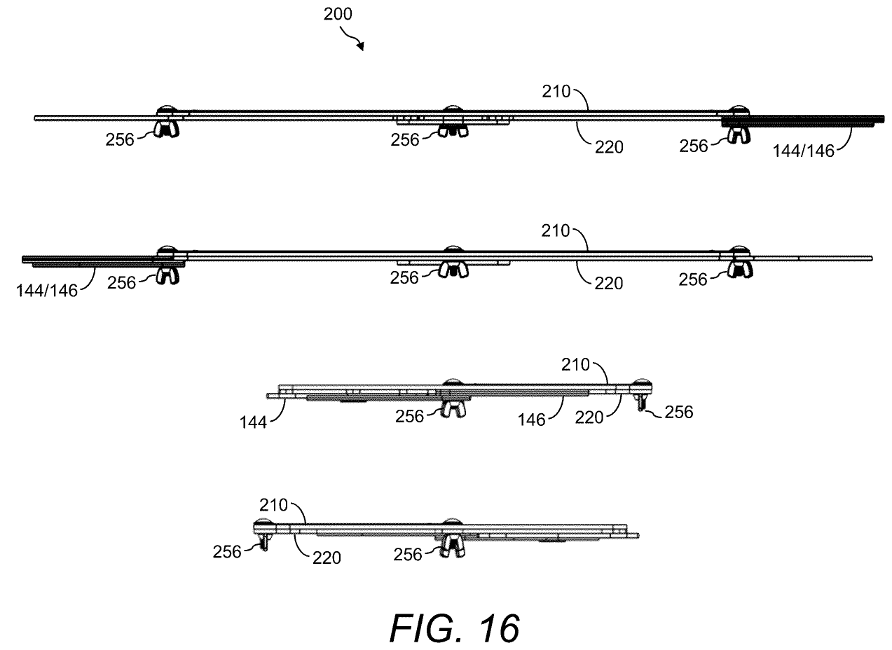

Referring now to FIG. 10 and FIG. 11 is a top perspective view and a bottom perspective view, respectively, of an example easel attachment 200 that may be used with the art palette 100 shown in FIG. 1 through FIG. 9, in accordance with an example embodiment of the invention. Further, FIG. 12 and FIG. 13 is a top exploded view and a bottom exploded view, respectively, of the easel attachment 200. Further, FIG. 14 and FIG. 15 is a top plan view and a bottom plan view, respectively, of the easel attachment 200. Further, FIG. 16 is side views and end views of the easel attachment 200.

Referring still to FIG. 10 though FIG. 16, when in use with the art palette 100, the easel attachment 200 may provide a structure and workspace for supporting any painting/drawing surface, such as, but not limited to, a sketchbook, an art book, a notebook, a small canvas panel, and/or the like. Additionally, when in use with the art palette 100, the easel attachment 200 may provide a mechanism for mounting to any standard tripod. That is, the art palette 100 may be attached to the easel attachment 200 to provide a hands-free plein air workspace when mounted on any standard tripod.

In this example, the easel attachment 200 may include a top plate 210 aligned atop a bottom support 220. The top plate 210 may include some number and arrangement of fastener points 212. The bottom support 220 may include a first portion 222 and a second tripod portion 224. The bottom support 220 may include some number and arrangement of fastener points 226.

Further, a cord 234, such as an elastic cord, may be provided atop the top plate 210. For example, the cord 234 may be stretched side-to-side of the top plate 210. Also, in one example, the center of the elastic cord 234 may be pulled down and secured to the bottom edge of the top plate 210 as shown in FIG. 10. The elastic cord 234 may include end loops 236 for fastening to the easel attachment 200. The elastic cord 234 on the lower part of the easel attachment 200 may be used to hold down the lower edges of a notebook, single sheet of paper, canvas panel, watercolor block, and/or the like.

Further, the easel attachment 200 may include a tripod plate 250 mounted on the underside of the bottom support 220. The tripod plate 250 may include a center opening 252 for receiving a tripod fastener 254. The tripod fastener 254 may be, for example, a threaded nut, e.g., a ¼ inch-20 thread nut. Accordingly, the tripod plate 250 may be used to interface with any standard tripod.

Further, the easel attachment 200 may include one or more arrangements of paddle attachments 140. In one example, the easel attachment 200 may include an arrangement of one or more cup holder paddles 142, one or more brush holder paddles 144 and/or one or more mixing tray paddles 146.

Additionally, various fasteners 256 may be used for assembling together the top plate 210, the bottom support 220, the tripod plate 250, and the paddle attachments 140. In one non-limiting example, each of the fasteners 256 may be a bolt and a wing nut. However, any other suitable mechanism may be used.

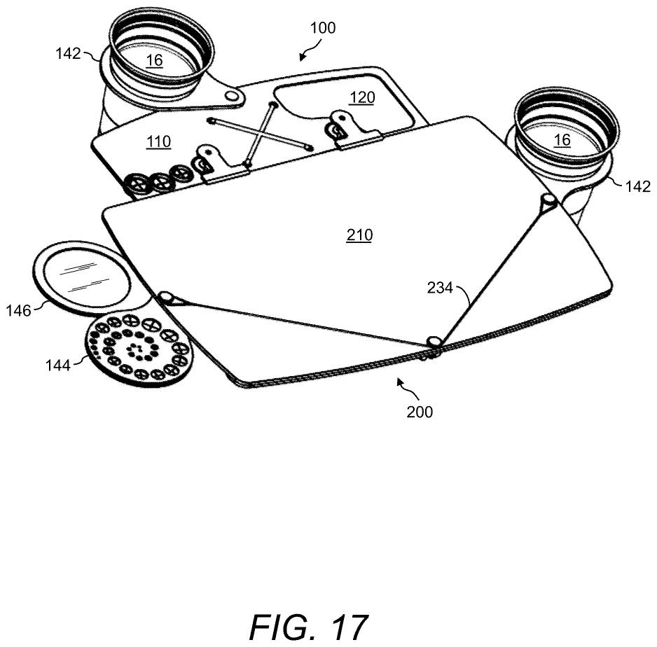

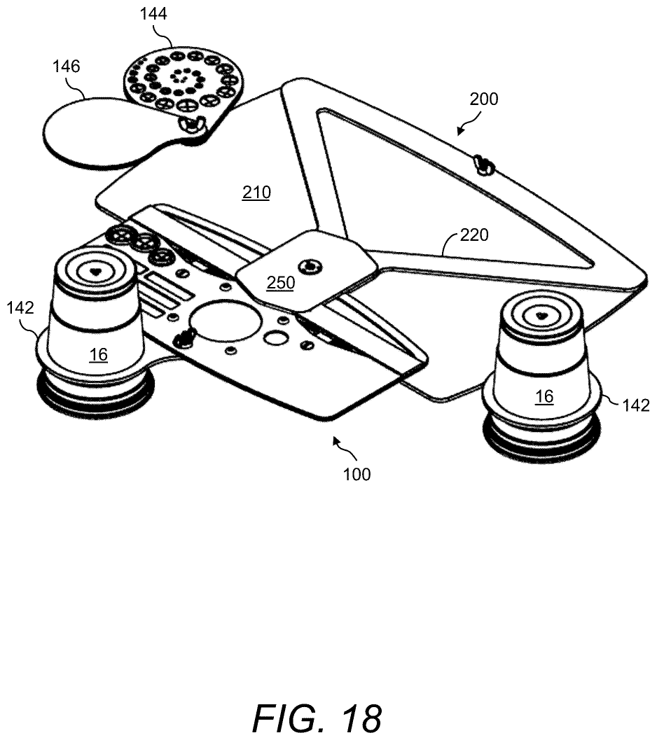

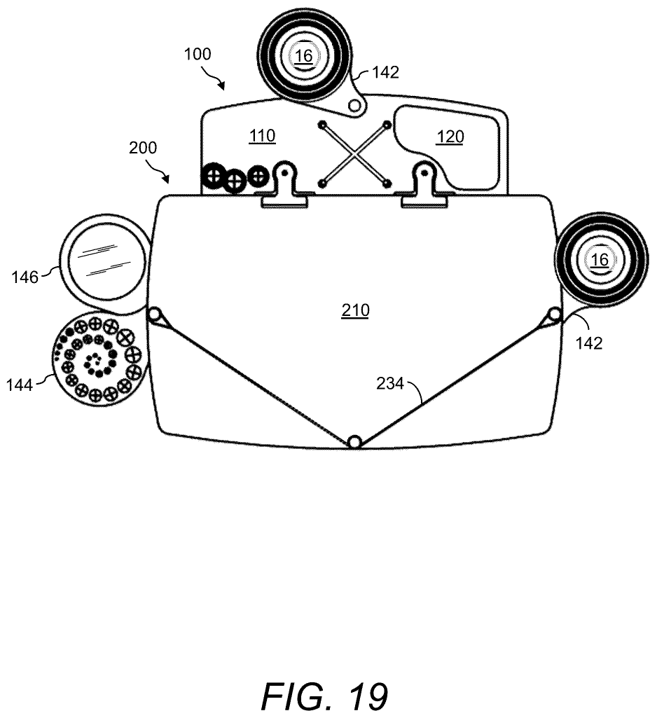

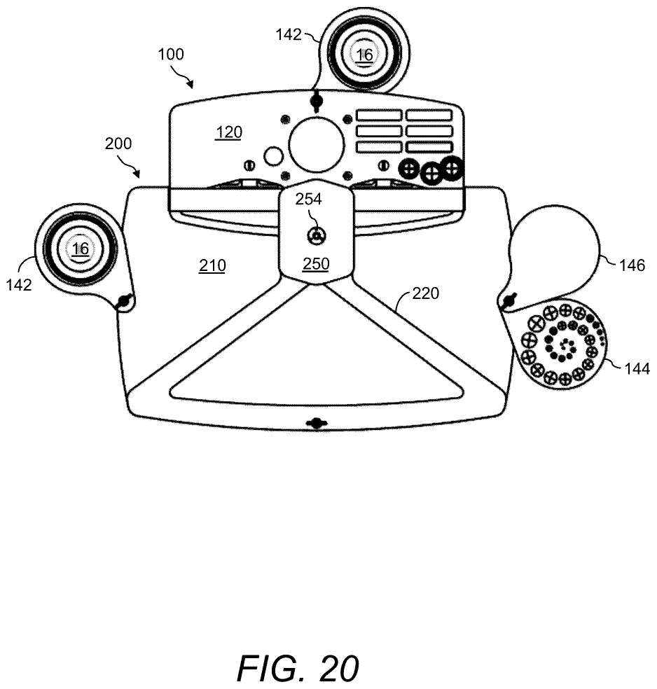

Referring now to FIG. 17 and FIG. 18 is a top perspective view and a bottom perspective view, respectively, of an example of the art palette 100 shown in FIG. 1 through FIG. 9 and the easel attachment 200 shown in FIG. 10 through FIG. 16 in use together, in accordance with an embodiment of the invention. Further, FIG. 19 and FIG. 20 is a top plan view and a bottom plan view, respectively, of an example of the art palette 100 shown in FIG. 1 through FIG. 9 and the easel attachment 200 shown in FIG. 10 through FIG. 16 in use together.

The easel attachment 200 may attach to the art palette 100 by the lower part of the art palette 100 being sandwiched between the bottom support 220 and the tripod plate 250. The two clips 132 may be used to further secure the art palette 100 to the easel attachment 200.

FIG. 17, FIG. 18, FIG. 19, and FIG. 20 show both the art palette 100 and the easel attachment 200 holding a plastic cup 16. In one example, the plastic cup 16 may be the “Red 16 oz. plastic cup” brand.

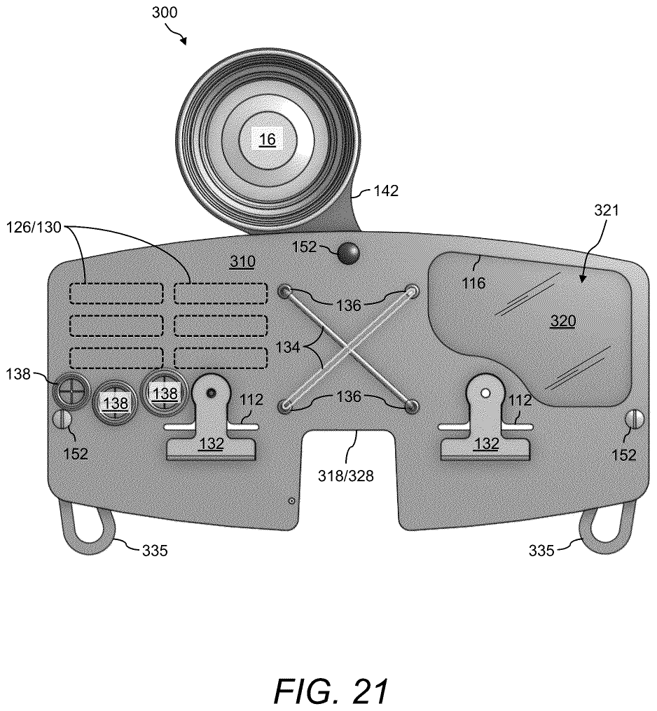

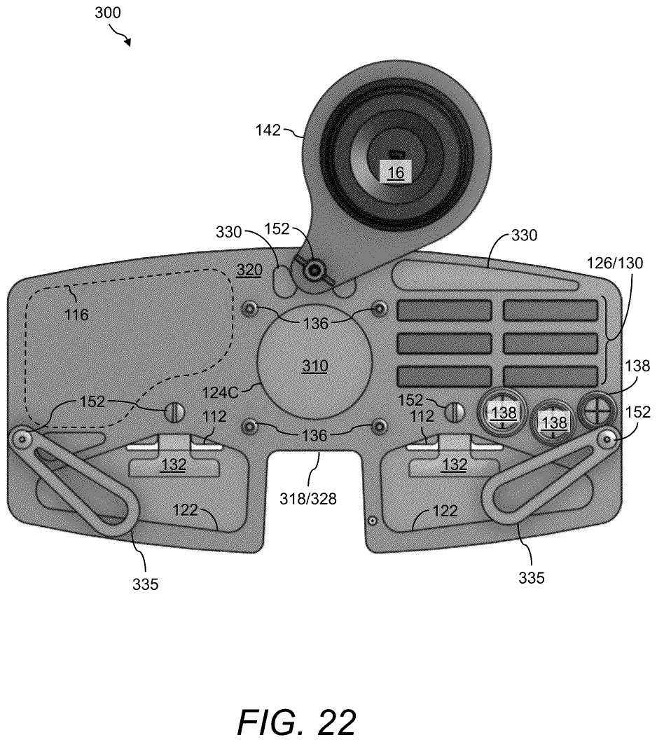

Referring now to FIG. 21 and FIG. 22 is a top plan view and a bottom plan view, respectively, of an art palette 300, in accordance with another embodiment of the invention. Generally, the features of the art palette 300 may be substantially similar to those of the art palette 100 shown and described in FIG. 1 through FIG. 9. The art palette 300 is another example of a portable art palette.

The art palette 300 may include a top plate 310 and a bottom plate 320 that may be fitted together. Like the top plate 110 of the art palette 100, the top plate 310 of the art palette 300 may include the two clip clearance openings 112, the arrangement of circular openings 114, the one or more paddle attachment openings 115, the mixing tray opening 116. Further, the top plate 310 may include a notch 318 and a mixing tray region 321 formed by the mixing tray opening 116.

The art palette 300 is not limited to a two-piece structure including the top plate 310 and the bottom plate 320. This is exemplary only. In another example, the art palette 300 may be formed of one piece or layer of molded/formed plastic.

Further, like the bottom plate 120 of the art palette 100, the bottom plate 320 of the art palette 300 may include the two clip clearance openings 122, the arrangement of circular openings 124, the one or more paddle attachment openings 125, the one or more magnet openings 126. Further, the bottom plate 320 may include a notch 328 and an arrangement of other openings 330.

Further, like the art palette 100, the art palette 300 may include magnets 130, the clips 132, the arrangement of elastic cords 134 and thru-hole grommets 136, the slotted grommets 138, at least one paddle attachment 140 (e.g., the cup holder paddle 142), and various fasteners 152.

Further, the art palette 300 may include locking arms 335. Each of the locking arms 335 may have a narrow end and a wide end. Each of the locking arms 335 may be coupled at its narrow end to the art palette 300 in pivoting fashion using a fastener 152, as shown in FIG. 22.

The top plate 310, the bottom plate 320, and the locking arms 335 of the art palette 300 may be formed of lightweight material, such as, but not limited to, molded plastic or aluminum. In one specific example, the top plate 310, the bottom plate 320, and the locking arms 335 of the art palette 300 may be formed of white plastic such that the entire workspace surface can be used as a palette because of the characteristics of the white plastic.

Referring now again to FIG. 21 and FIG. 22, used alone the art palette 300 may provide a handheld workspace (e.g., handheld plein air workspace). Further, while the handle 150 described with respect to the art palette 100 is not shown in FIG. 21 and FIG. 22, optionally the art palette 300 may include the handle 150.

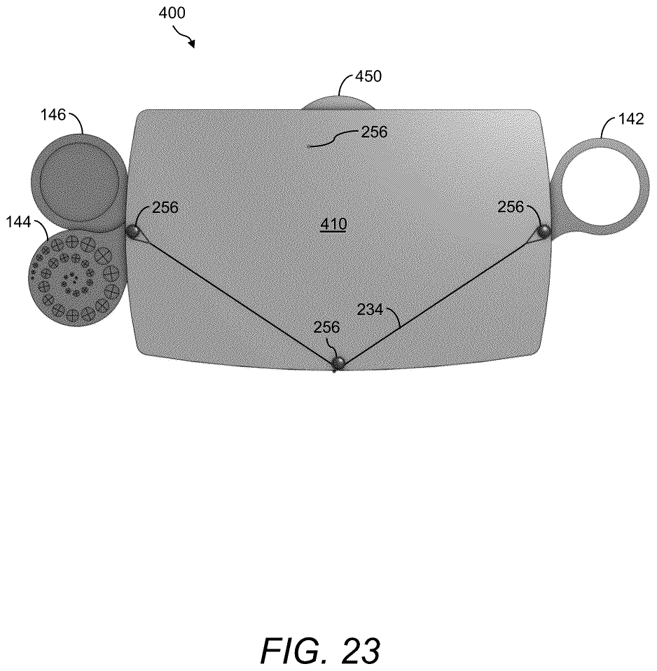

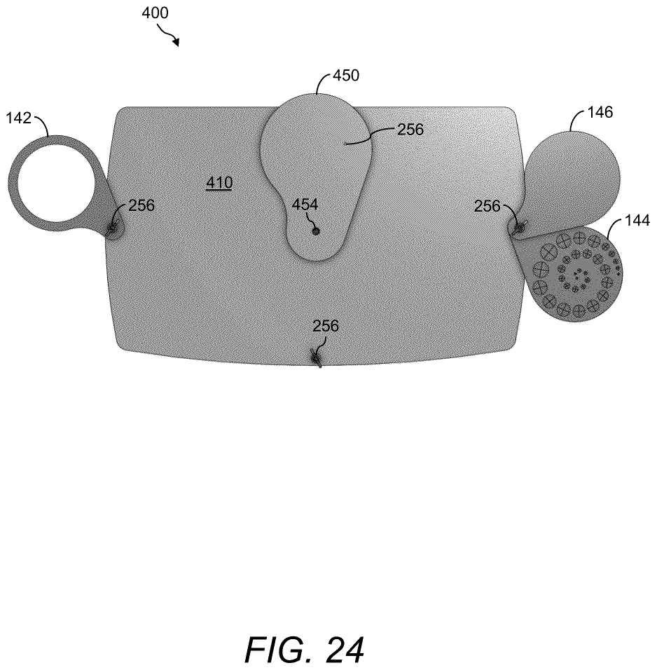

Referring now to FIG. 23 and FIG. 24 is a top plan view and a bottom plan view, respectively, of an easel attachment 400 for use with the art palette 300 shown in FIG. 21 and FIG. 22, in accordance with another embodiment of the invention. When in use with the art palette 300, the easel attachment 400 may provide a structure and workspace for supporting any painting/drawing surface, such as, but not limited to, a sketchbook, an art book, a notebook, a small canvas panel, and/or the like. Additionally, when in use with the art palette 300, the easel attachment 400 may provide a mechanism for mounting to any standard tripod. That is, the art palette 300 may be attached to the easel attachment 400 to provide a hands-free workspace when mounted on any standard tripod.

In one example the easel attachment 400 may include an easel plate 410 and a tripod plate 450. The easel plate 410 may include the arrangement of fastener openings 212, the elastic cord 234 with end loops 236, and various fasteners 256 as described above with respect to the easel attachment 200 shown in FIG. 10 through FIG. 16.

In the easel attachment 400, the easel plate 410 may be substantially the same as the top plate 210 of the easel attachment 200. Like the easel attachment 200, the easel attachment 400 may include any arrangement of one or more paddle attachments 140. For example, one cup holder paddle 142, one brush holder paddle 144, and one mixing tray paddle 146.

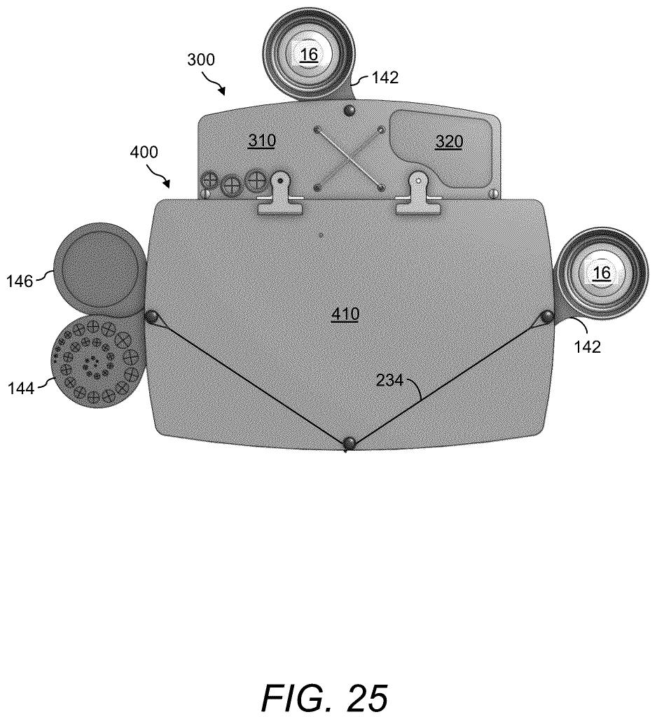

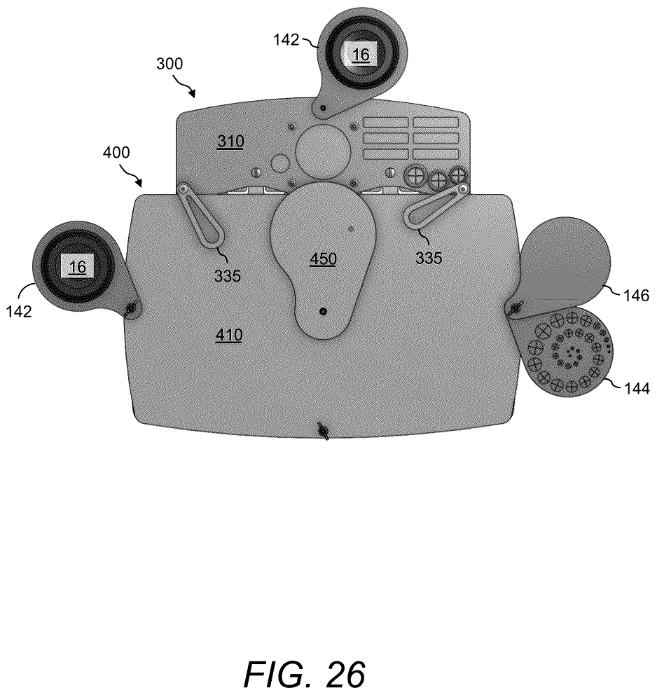

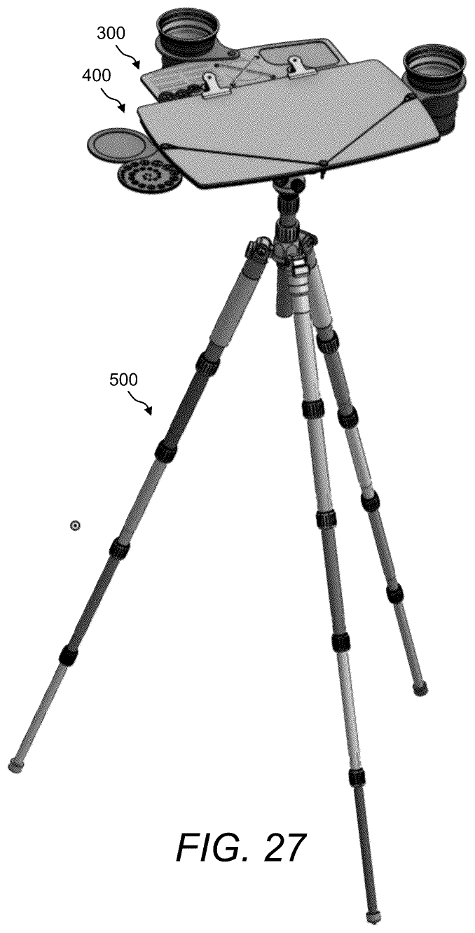

Additionally, the tripod plate 450 may be fastened in pivoting fashion to the underside of the easel plate 410 using a fastener 256. Further, a tripod fastener 454 may be provided in the tripod plate 450, as shown in FIG. 24. The tripod fastener 454 may be, for example, a threaded nut, such as a ¼ inch-20 thread nut. The tripod fastener 454 may be used for mounting the easel attachment 400 to a standard tripod, as shown in FIG. 27. Accordingly, the tripod plate 450 may be used to interface with any standard tripod. Referring now to FIG. 25 and FIG. 26 is a top plan view and a bottom plan view, respectively, of an example of the art palette 300 shown in FIG. 21 and FIG. 22 and the easel attachment 400 shown in FIG. 23 and FIG. 24 in use together, in accordance with another embodiment of the invention. FIG. 25 and FIG. 26 show both the art palette 300 and the easel attachment 400 holding a plastic cup 16.

In one example, the locking arms 335 of the art palette 300 may be used to help support an easel attachment (e.g., easel attachment 400) attached thereto, or to help support the back cover of a sketchbook, journal (not shown) such that the flaps of the sketchbook do not hang down or have to be held.

Referring now to FIG. 27 is a perspective view of an example of the art palette 300 and easel attachment 400 shown in FIG. 25 and FIG. 26 mounted atop a standard tripod 500, in accordance with an embodiment of the invention. Accordingly, the art palette 300 attached to the easel attachment 400 that is attached to the tripod 500 may provide a hands-free plein air workspace.

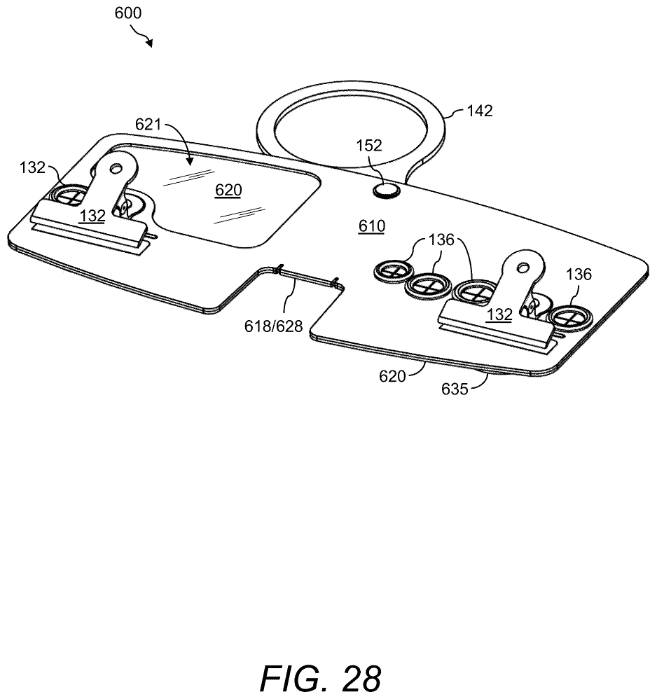

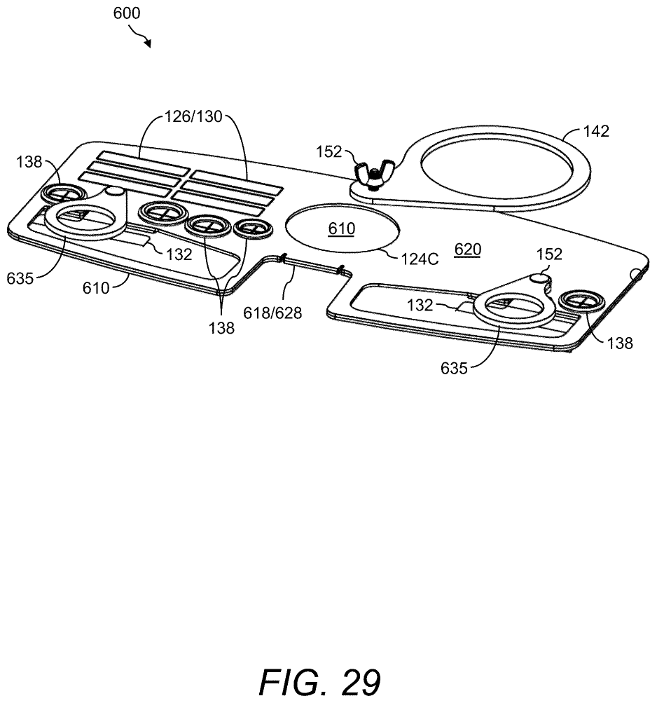

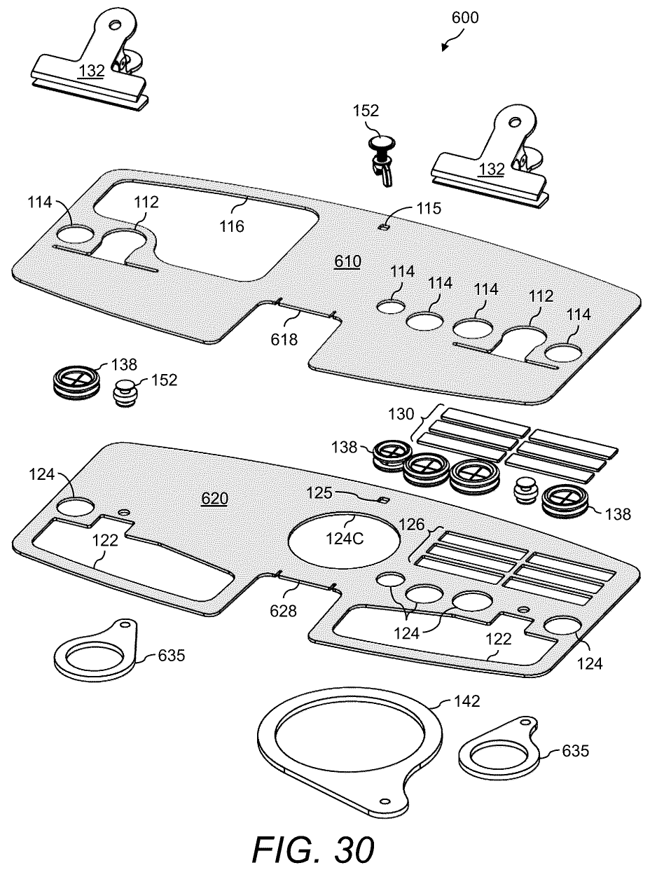

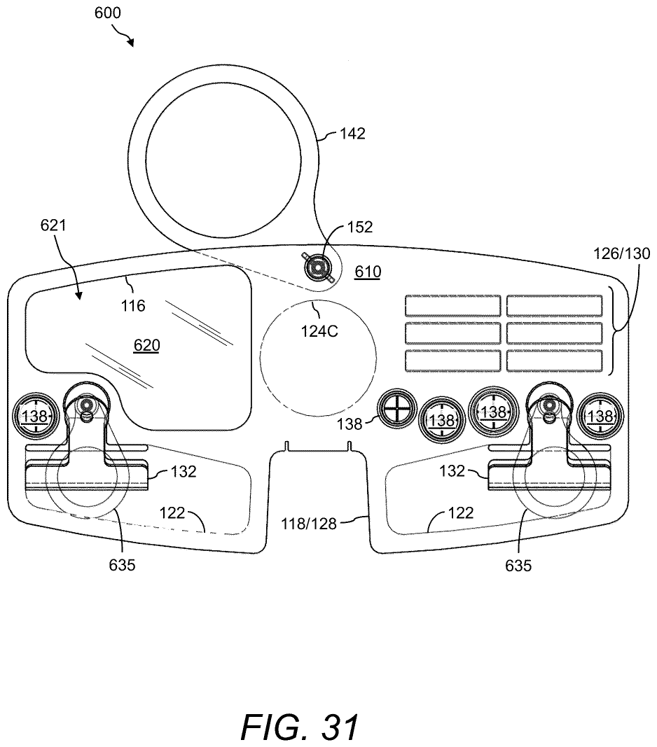

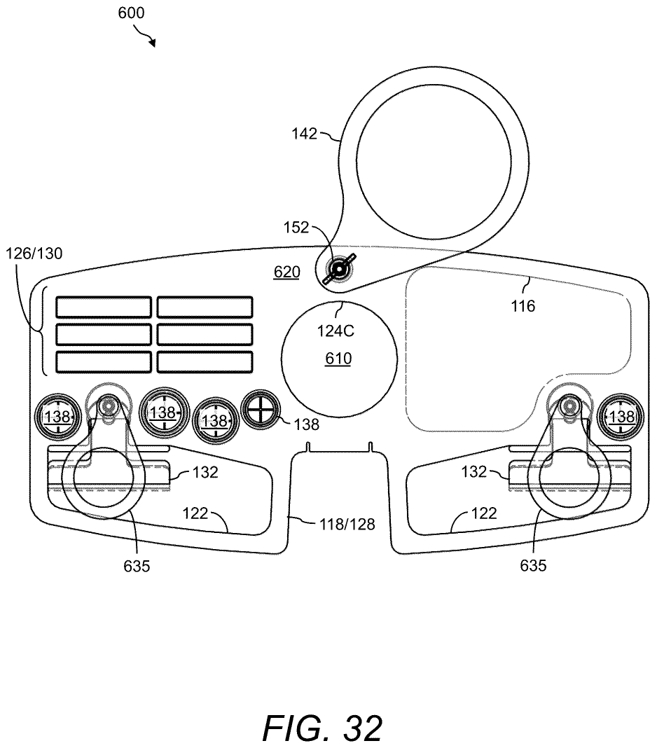

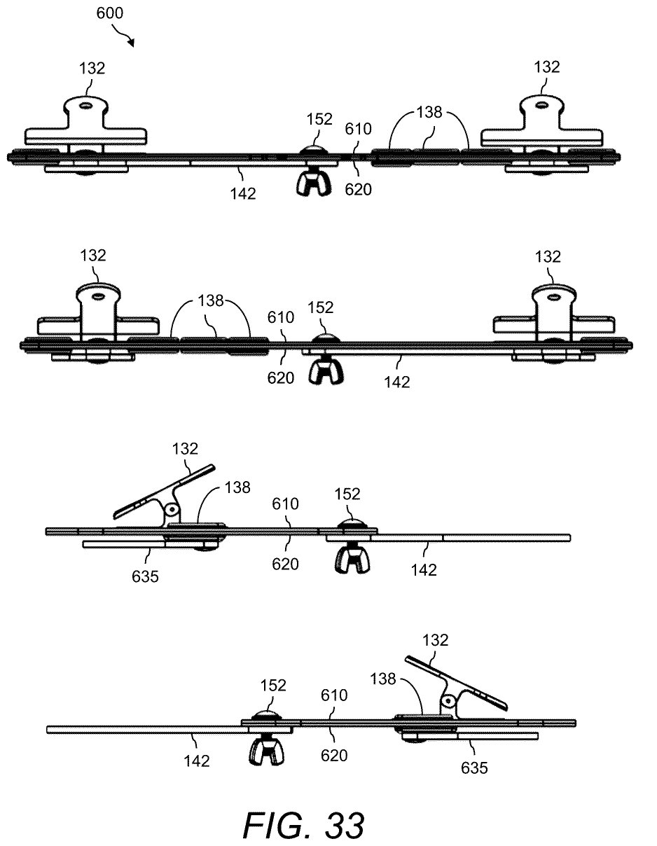

Referring now to FIG. 28 and FIG. 29 is a top perspective view and a bottom perspective view, respectively, of an art palette 600, in accordance with yet another embodiment of the invention. Further, FIG. 30, FIG. 31, and FIG. 32 is an exploded view, a top plan view, and a bottom plan view, respectively, of the art palette 600. Further, FIG. 33 is side views and end views of the art palette 600. The art palette 600 is yet another example of a portable art palette.

Referring now to FIG. 28 through FIG. 33, the art palette 600 may include a top plate 610 and a bottom plate 620 that may be fitted together. In one example, the top plate 610 and the bottom plate 620 may have substantially the same outer footprint and dimensions as the top plate 110 and the bottom plate 120 of the art palette 100, respectively. The top plate 610 may include a notch 618. The bottom plate 620 may include a notch 628.

The art palette 600 is not limited to a two-piece structure including the top plate 610 and the bottom plate 620. This is exemplary only. In another example, the art palette 600 may be formed of one piece or layer of molded/formed plastic.

Generally, the art palette 600 may include some of the same features as those of the art palette 100 shown and described in FIG. 1 through FIG. 9, albeit implemented differently. For example, the art palette 600 may include additional slotted grommets 138. Further, the art palette 600 may include a mixing tray region 621 in a different location than the mixing tray region 121 of the art palette 100, However, it could be in the same location. Further, the art palette 600 may include a set of magnets 130 located differently than those of the art palette 100. However, they could be in the same location. As a result, the magnet openings 126 of the bottom plate 620 may be located differently than those of the bottom plate 120.

Further, the art palette 600 may include the two clips 132. Accordingly, the top plate 610 of the art palette 600 may include the two clip clearance openings 112. Further, the bottom plate 620 may include the two clip clearance openings 122.

The top plate 610 of the art palette 600 may include an arrangement of circular openings 114 that supports its features. Further, the top plate 610 may include one or more paddle attachment openings 115. Likewise, the bottom plate 620 may include an arrangement of circular openings 124 (including circular opening 124C) that supports its features. Further, the bottom plate 620 may include one or more paddle attachment openings 125. Further, the art palette 600 may include an arrangement of fasteners 152 that supports its features.

Further, the art palette 600 may include locking paddles 635 installed on the underside of the bottom plate 620. Each of the locking paddles 635 may have a fastening portion and a paddle portion, as shown. Each of the locking paddles 635 may be coupled at its fastening portion to the art palette 600 in pivoting fashion using a fastener 152, as shown in FIG. 29.

The top plate 610, the bottom plate 620, and the locking paddles 635 of the art palette 600 may be formed of lightweight material, such as, but not limited to, molded plastic or aluminum. In one example, the top plate 610, the bottom plate 620, and the locking paddles 635 of the art palette 600 may be formed of white plastic such that the entire workspace surface can be used as a palette because of the characteristics of the white plastic.

Referring now again to FIG. 28 through FIG. 33, used alone the art palette 600 may provide a handheld workspace. Further, while the handle 150 described with respect to the art palette 100 is not shown in FIG. 28 through FIG. 33, optionally the art palette 600 may include the handle 150.

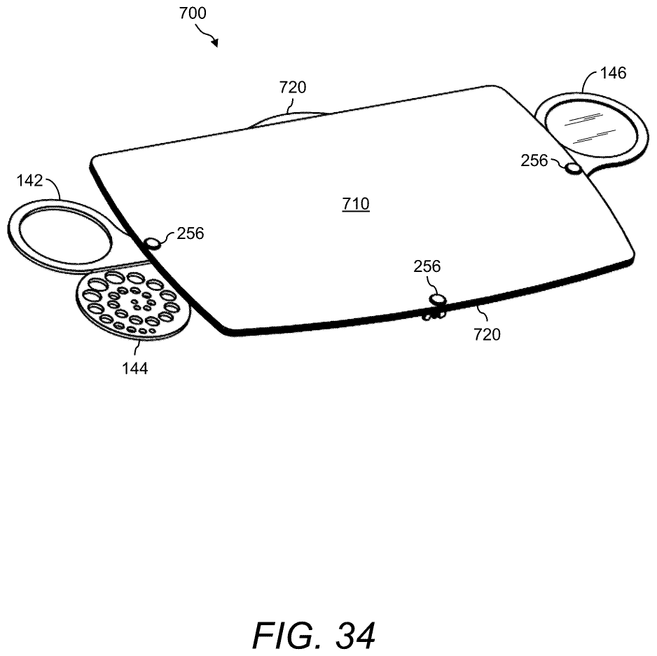

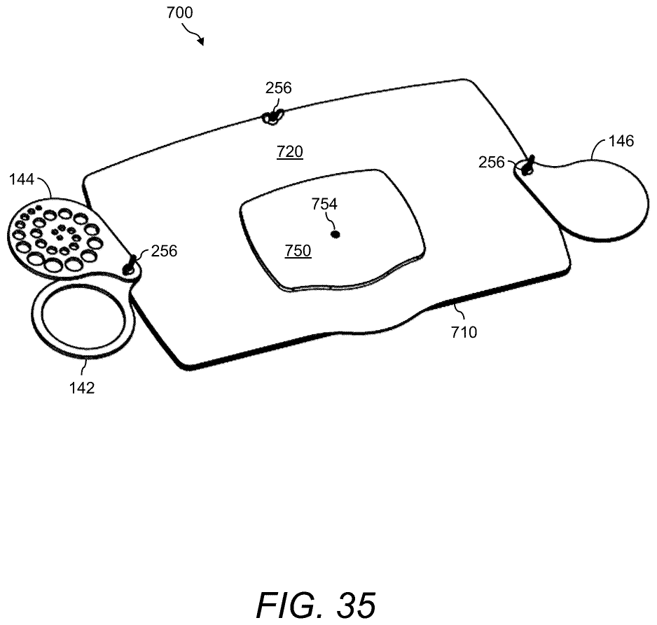

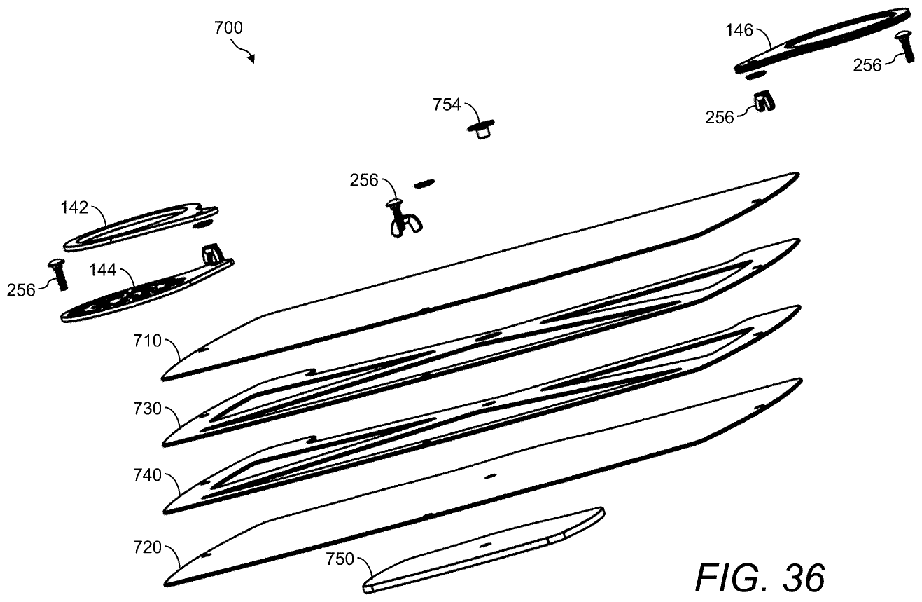

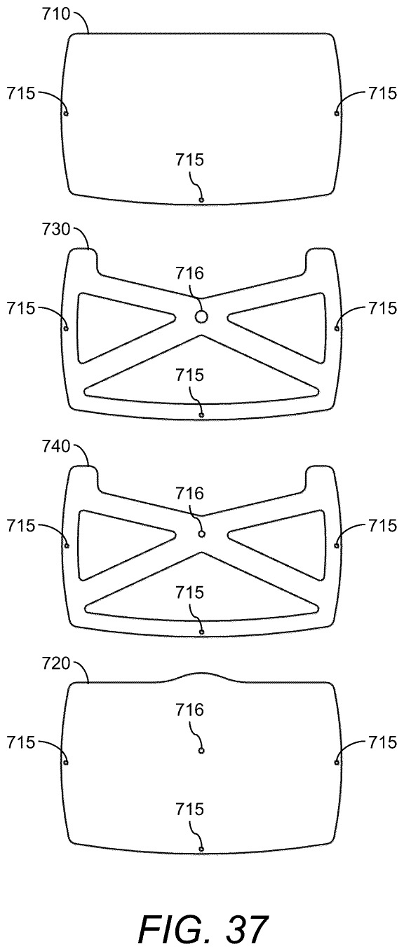

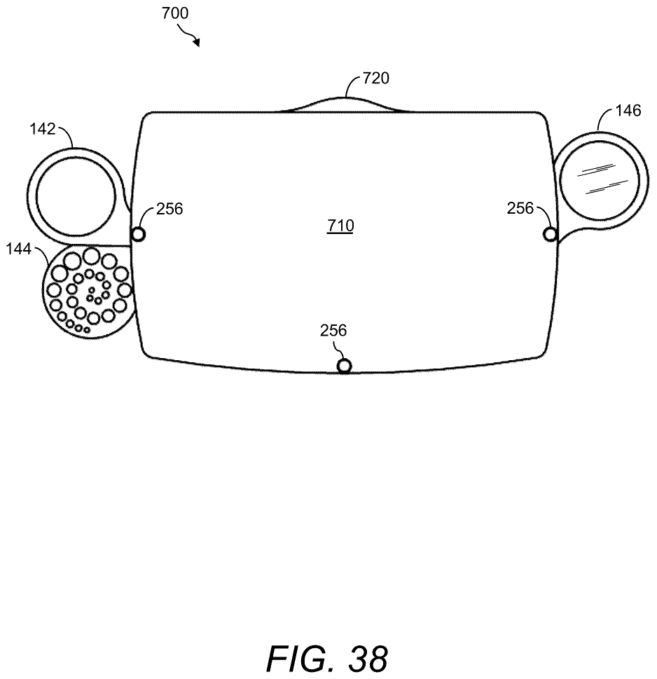

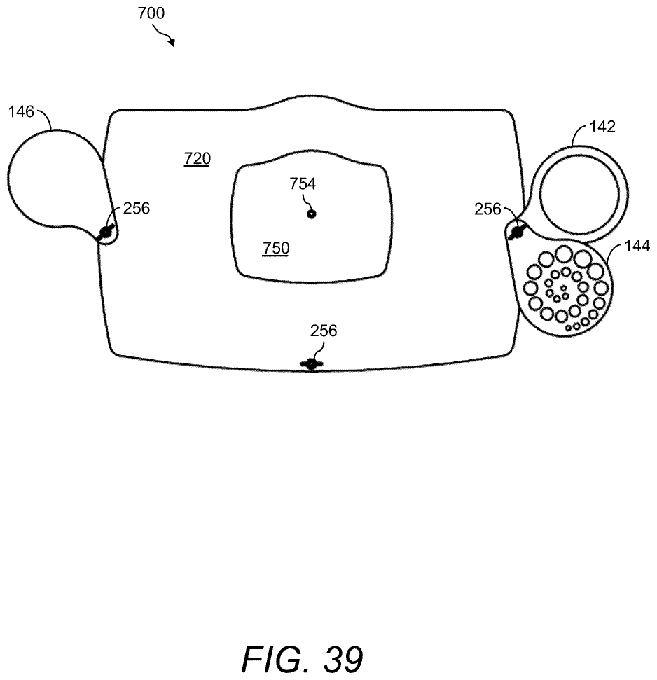

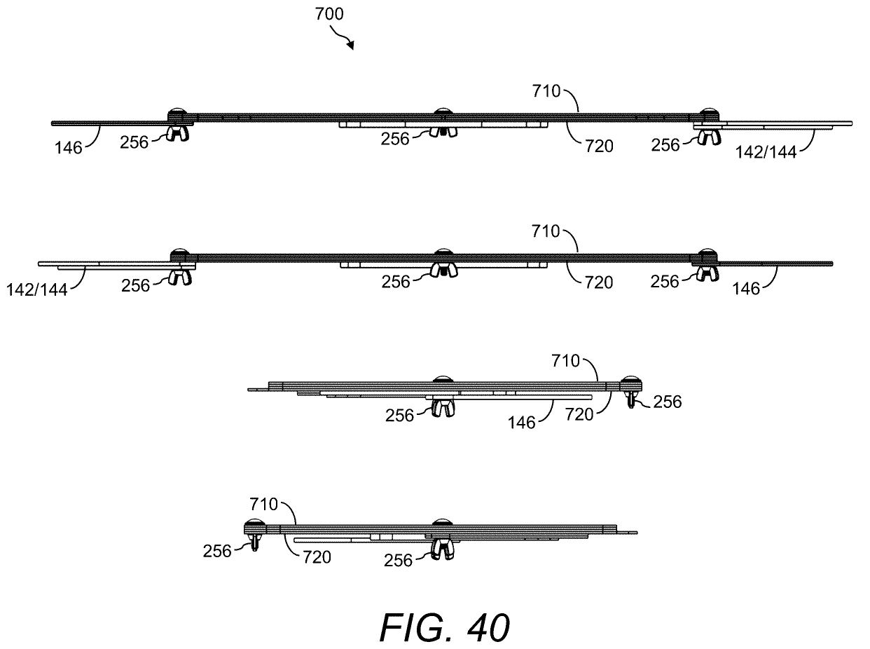

Referring now to FIG. 34 and FIG. 35 is a top perspective view and a bottom perspective view, respectively, of an easel attachment 700 for use with the art palette 600 shown in FIG. 28 through FIG. 33, in accordance with yet another embodiment of the invention. Further, FIG. 36 is a top exploded view of the easel attachment 700. Further, FIG. 37 is top plan views of the plates forming the easel attachment 700. Further, FIG. 38 and FIG. 39 is a top plan view and a bottom plan view, respectively, of the easel attachment 700. Further, FIG. 40 is side views and end views of the easel attachment 700.

Referring now to FIG. 34 through FIG. 40, when in use with the art palette 600, the easel attachment 700 may provide a structure and workspace for supporting any painting/drawing surface, such as, but not limited to, a sketchbook, an art book, a notebook, a small canvas panel, and/or the like. Additionally, when in use with the art palette 600, the easel attachment 700 may provide a mechanism for mounting to any standard tripod. That is, the art palette 600 may be attached to the easel attachment 700 to provide a hands-free plein air workspace when mounted on any standard tripod.

Referring still to FIG. 34 through FIG. 40, the easel attachment 700 may include a top plate 710, a first inner support 730, a second inner support 740, and a bottom plate 720 that may be fitted together. FIG. 36 shows an example of the stack of the top plate 710, the first inner support 730, the second inner support 740, and the bottom plate 720 of the easel attachment 700. In one example, the top plate 710, the bottom plate 720, the first inner support 730, and the second inner support 740 may have substantially the same outer footprint and dimensions as the top plate 210 of the easel attachment 200 shown in FIG. 10 through FIG. 16.

FIG. 37 shows more details of the top plate 710, the first inner support 730, the second inner support 740, and the bottom plate 720 of the easel attachment 700. For example, each of the top plate 710, the first inner support 730, the second inner support 740, and the bottom plate 720 may include one or more (e.g., three) paddle attachment openings 715 for installing one or more paddle attachments 140. Further, each of the first inner support 730, the second inner support 740, and the bottom plate 720 may include a center opening 716.

The easel attachment 700 is not limited to a four-piece structure including the stack of the top plate 710, the first inner support 730, the second inner support 740, and the bottom plate 720. This is exemplary only. In another example, the stack of the top plate 710, the first inner support 730, the second inner support 740, and the bottom plate 720 may be formed of one piece or layer of molded/formed plastic.

Further, the easel attachment 700 may include a tripod plate 750 mounted on the underside of the bottom plate 720. The tripod plate 750 may include a center opening 752 (not show) for receiving a tripod fastener 754. The tripod fastener 754 may be, for example, a threaded nut, such as a ¼ inch-20 thread nut. Accordingly, the tripod plate 750 may be used to interface with any standard tripod.

Additionally, various fasteners 256 may be used for assembling together the top plate 710, the first inner support 730, the second inner support 740, the bottom plate 720, the tripod plate 750, and the paddle attachments 140. In one example, each of the fasteners 256 may be a bolt and a wing nut.

Further, while the elastic cord 234 described with respect to the easel attachment 200 and the easel attachment 400 is not shown in FIG. 34 through FIG. 40, optionally the easel attachment 700 may include an arrangement of elastic cord 234 installed atop the top plate 710.

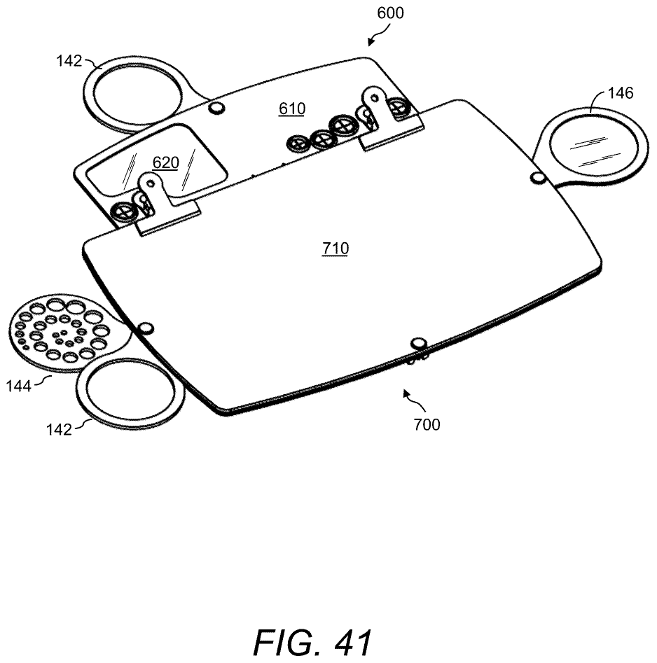

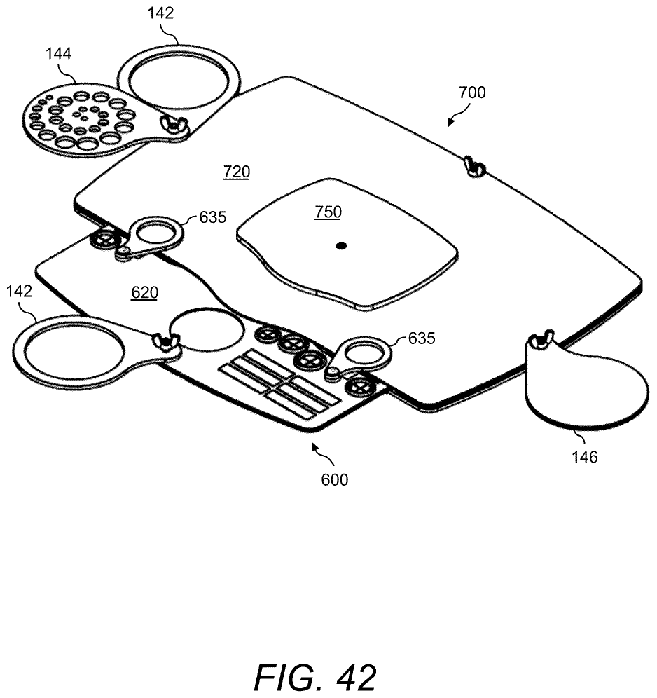

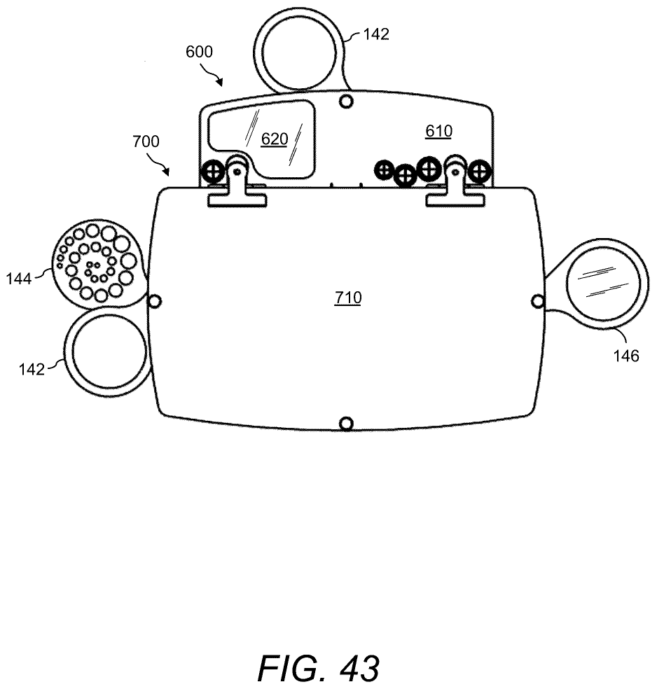

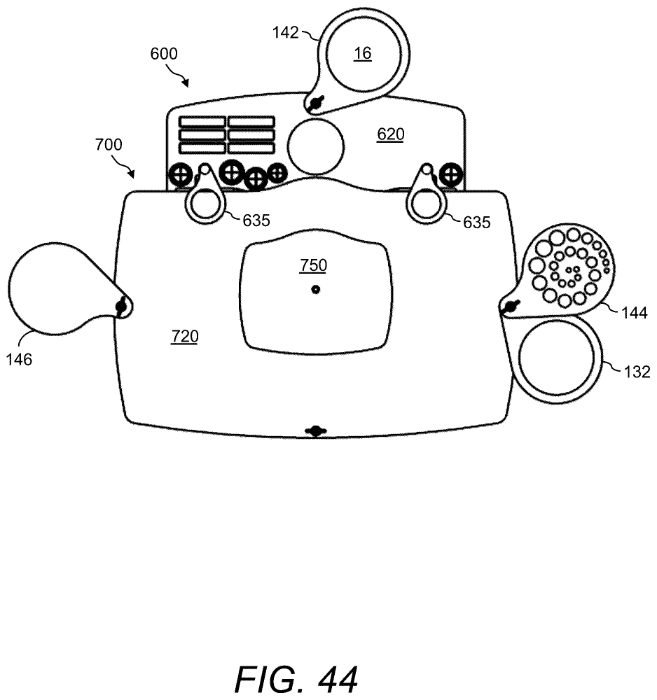

Referring now to FIG. 41 and FIG. 42 is a top perspective view and a bottom perspective view, respectively, of an example of the art palette 600 shown in FIG. 28 through FIG. 33 and the easel attachment 700 shown in FIG. 34 through FIG. 40 in use together, in accordance with yet another embodiment of the invention. Further, FIG. 43 and FIG. 44 is a top plan view and a bottom plan view, respectively, of an example of the art palette 600 shown in FIG. 28 through FIG. 33 and the easel attachment 700 shown in FIG. 34 through FIG. 40 in use together.

In this example, the locking paddles 635 of the art palette 600 may be used to help support an easel attachment (e.g., easel attachment 700) attached thereto, or to help support the back cover and/or pages of a sketchbook (not shown) that are not being held in the clips 132. Further, the clips 132 may be the sole means of coupling the art palette 600 to the easel attachment 700.

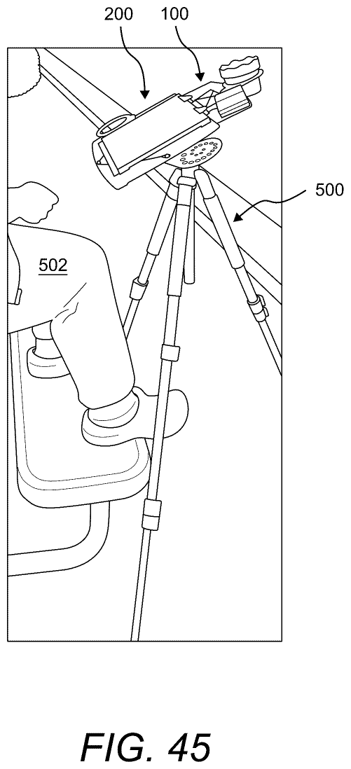

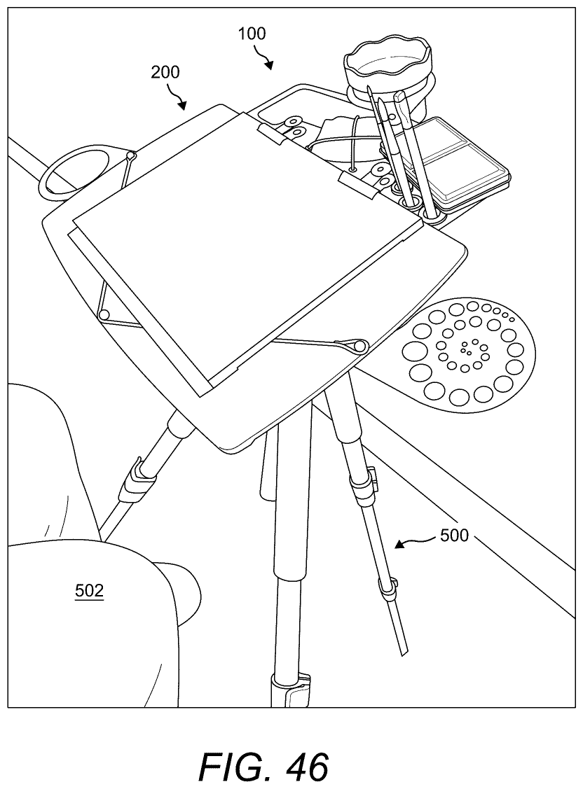

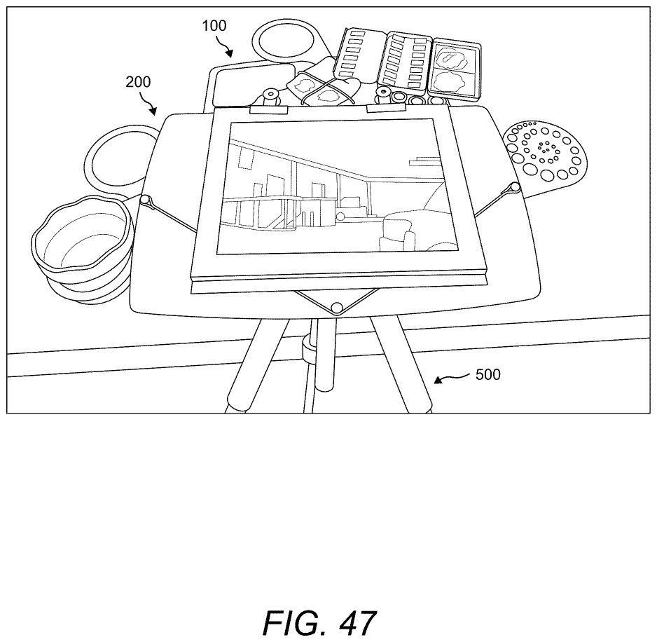

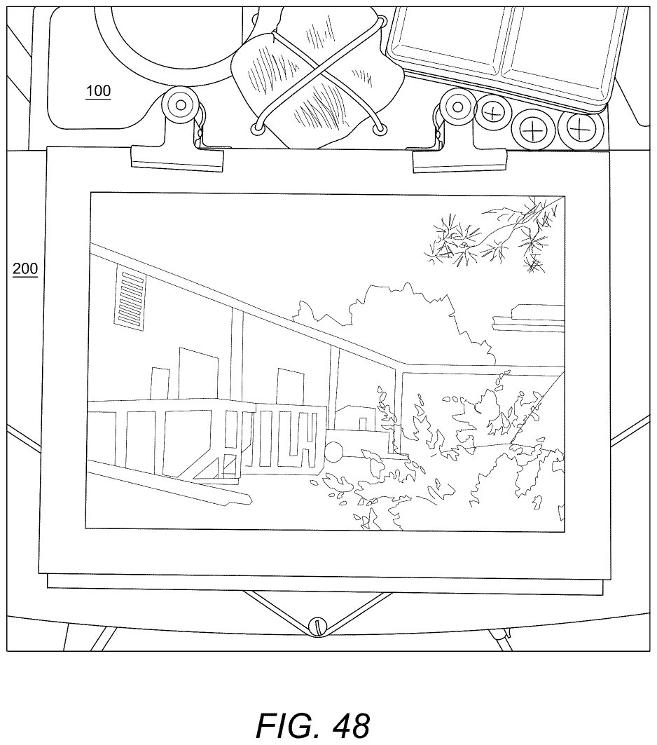

Further to the examples, FIG. 45, FIG. 46, FIG. 47, and FIG. 48 show photos of an example of the art palette 100 and the easel attachment 200 in use, in accordance with an embodiment of the invention. FIG. 45, FIG. 46, FIG. 47, and FIG. 48 also show a user or artist 502 sitting in relation to the assembly of the art palette 100 and the easel attachment 200 mounted atop the standard tripod 500. Here, the user or artist 502 may enjoy a hands-free plein air workspace.

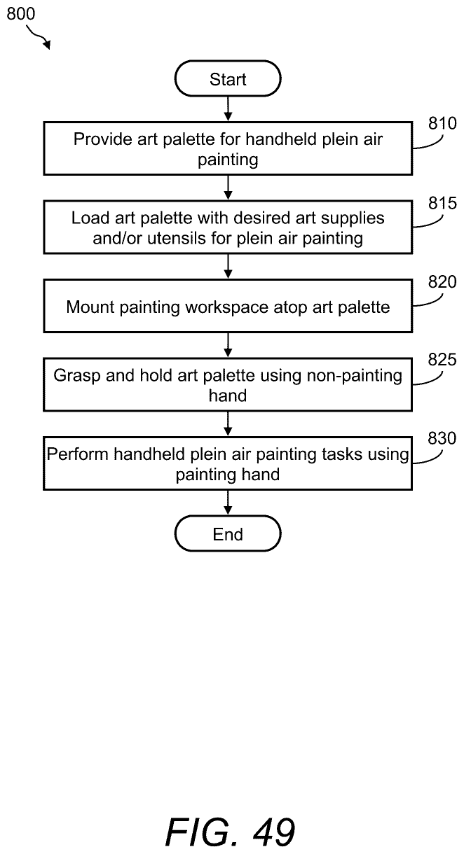

Referring now to FIG. 49 is a flow diagram of an example of a method 800 of using the art palettes 100, 300, 600 as a handheld plein air workspace, in accordance with an embodiment of the invention. Method 800 may include, but is not limited to, the following steps.

At a step 810, an art palette is provided for handheld plein air painting. In one example, the art palette 100 shown in FIG. 1 through FIG. 9 may be provided for handheld plein air painting. In another example, the art palette 300 shown in FIG. 21 and FIG. 22 may be provided for handheld plein air painting. In yet another example, the art palette 600 shown in FIG. 28 through FIG. 33 may be provided for handheld plein air painting.

At a step 815, the art palette is loaded with desired art supplies and/or utensils for plein air painting. In one example, the art palette 100 shown in FIG. 1 through FIG. 9 may be loaded with desired art supplies and/or utensils for watercolor plein air painting. More specifically, FIG. 1 shows an example of the art palette 100 equipped with certain watercolor paint utensils, such as brushes 12, pencils 14, a plastic cup 16, and a metal watercolor tin or half pan 18.

At a step 820, the painting workspace is mounted atop the art palette. For example, using clips 132 of the art palettes 100, 300, 600 any type of watercolor workspace (e.g., sketchbook, art book, notebook, small canvas panel) for painting can be held thereon. More specifically, FIG. 1 shows an example of the art palette 100 using two clips 132 to hold a sketchbook 10.

At a step 825, the user grasps and holds the art palette using his/her non-painting hand. For example, the user grasps and holds the art palette 100, 300, 600 using his/her non-painting hand. In one example, using his/her non-painting hand, the user may grasp and hold the handle 150 on the underside of the art palette 100.

At a step 830, the user performs handheld plein air painting tasks using his/her painting hand. For example, while holding the art palette 100, 300, 600 using his/her non-painting hand, the user performs painting tasks using his/her painting hand. In this way, the art palettes 100, 300, 600 may provide a handheld painting workspace.

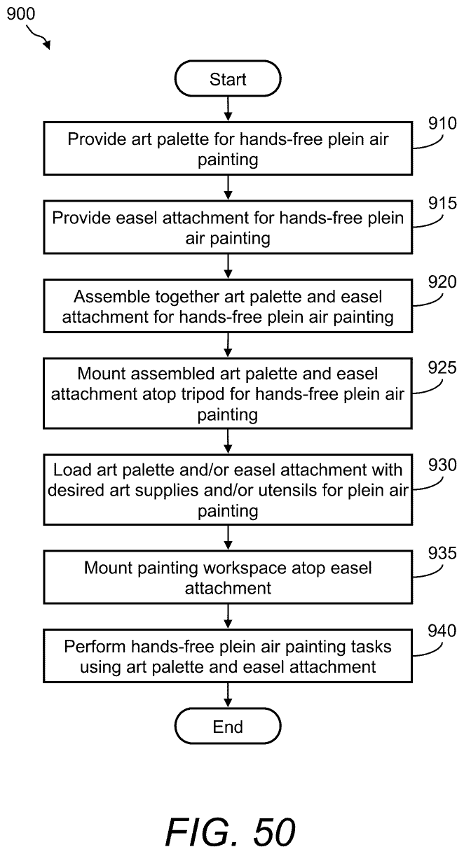

FIG. 50 illustrates a flow diagram of an example of a method 900 of using the art palettes 100, 300, 600 and the easel attachments 200, 400, 700 as a hands-free plein air workspace, in accordance with an embodiment of the invention. Method 900 may include, but is not limited to, the following steps.

At a step 910, an art palette is provided for hands-free painting. In one example, the art palette 100 shown in FIG. 1 through FIG. 9 may be provided for hands-free painting. In another example, the art palette 300 shown in FIG. 21 and FIG. 22 may be provided for hands-free painting. In yet another example, the art palette 600 shown in FIG. 28 through FIG. 33 may be provided for hands-free painting.

At a step 915, an easel attachment is provided for hands-free plein air painting. In one example, the easel attachment 200 shown in FIG. 10 through FIG. 16 may be provided for hands-free plein air painting. In another example, the easel attachment 400 shown in FIG. 23 and FIG. 24 may be provided for hands-free plein air painting. In yet another example, the easel attachment 700 shown in FIG. 34 through FIG. 40 may be provided for hands-free plein air painting.

At a step 920, the art palette and the easel attachment are assembled together for hands-free plein air painting. In one example, the art palette 100 and the easel attachment 200 may be assembled together for hands-free painting, as shown in FIG. 17 through FIG. 20. In another example, the art palette 300 and the easel attachment 400 may be assembled together for hands-free painting, as shown in FIG. 25 and FIG. 26. In yet another example, the art palette 600 and the easel attachment 700 may be assembled together for hands-free painting, as shown in FIG. 41 through FIG. 44.

At a step 925, the assembled art palette and easel attachment are mounted atop a standard tripod for hands-free painting. In one example, the art palette 100 and the easel attachment 200 may be mounted atop a standard tripod 500 for hands-free painting, as shown in FIG. 45, FIG. 46, FIG. 47, and FIG. 48. In another example, the art palette 300 and the easel attachment 400 may be mounted atop a standard tripod 500 for hands-free painting, as shown in FIG. 27. In yet another example, the art palette 600 and the easel attachment 700 may be mounted atop a standard tripod 500 for hands-free painting.

At a step 930, the art palette and/or easel attachment are loaded with the desired art supplies and/or utensils for painting, such as plein air painting. In one example, the art palette 100 and/or the easel attachment 200 may be loaded with the desired art supplies and/or utensils for painting, such as watercolor plein air painting, as shown in FIG. 45, FIG. 46, FIG. 47, and FIG. 48. In another example, the art palette 300 and/or the easel attachment 400 may be loaded with the desired art supplies and/or utensils for painting, such as watercolor plein air painting. In yet another example, the art palette 600 and/or the easel attachment 700 may be loaded with the desired art supplies and/or utensils for painting, such as watercolor plein air painting.

At a step 935, the painting workspace is mounted atop the easel attachment. For example, using clips 132 of the art palettes 100, 300, 600 any type of workspace (e.g., sketchbook, art book, notebook, small canvas panel) for painting may be mounted atop the easel attachment 200, 400, 700. An example of a workspace mounted atop the easel attachment 200 as shown in FIG. 45, FIG. 46, FIG. 47, and FIG. 48.

At a step 940, the user performs hands-free painting tasks using the art palette and the easel attachment. In one example, the user performs hands-free painting tasks using the art palette 100 and the easel attachment 200, as shown in FIG. 45, FIG. 46, FIG. 47, and FIG. 48. In another example, the user performs hands-free painting tasks using the art palette 300 and the easel attachment 400. In yet another example, the user performs hands-free painting tasks using the art palette 600 and the easel attachment 700.

In summary and referring now again to FIG. 1 through FIG. 50, in some embodiments, the portable art palettes 100, 300, 600 and method 800 provide a handheld painting workspace.

Further, in some embodiments, the portable art palettes 100, 300, 600 in combination with easel attachments 200, 400, 700, respectively, and method 900 provide a hands-free painting workspace.

Following long-standing patent law convention, the terms “a,” “an,” and “the” refer to “one or more” when used in this application, including the claims. Thus, for example, reference to “a subject” includes a plurality of subjects, unless the context clearly is to the contrary (e.g., a plurality of subjects), and so forth.

The terms “comprise,” “comprises,” “comprising,” “include,” “includes,” and “including,” are intended to be non-limiting, such that recitation of items in a list is not to the exclusion of other like items that may be substituted or added to the listed items.

Terms like “preferably,” “commonly,” and “typically” are not utilized herein to limit the scope of the claimed embodiments or to imply that certain features are critical or essential to the structure or function of the claimed embodiments. These terms are intended to highlight alternative or additional features that may or may not be utilized in a particular embodiment of the present invention.

The term “substantially” is utilized herein to represent the inherent degree of uncertainty that may be attributed to any quantitative comparison, value, measurement, or other representation and to represent the degree by which a quantitative representation may vary from a stated reference without resulting in a change in the basic function of the subject matter at issue.

Various modifications and variations of the disclosed methods, compositions and uses of the invention will be apparent to the skilled person without departing from the scope and spirit of the invention. Although the subject matter has been disclosed in connection with specific preferred aspects or embodiments, it should be understood that the subject matter as claimed should not be unduly limited to such specific aspects or embodiments.

For the purposes of this specification and appended claims, unless otherwise indicated, all numbers expressing amounts, sizes, dimensions, proportions, shapes, formulations, parameters, percentages, quantities, characteristics, and other numerical values used in the specification and claims, are to be understood as being modified in all instances by the term “about” even though the term “about” may not expressly appear with the value, amount or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the presently disclosed subject matter. For example, the term “about,” when referring to a value can be meant to encompass variations of, in some embodiments ±100%, in some embodiments ±50%, in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

Although the foregoing subject matter has been described in some detail by way of illustration and example for purposes of clarity of understanding, it will be understood by those skilled in the art that certain changes and modifications can be practiced within the scope of the appended claims.

That which is claimed:

1. A portable art palette comprising:
a. a plate body defining an upper surface and a lower surface;
b. a notch formed along an edge of the plate body;
c. a mixing tray region defined in a portion of the upper surface of the plate body, the mixing tray region providing a paint mixing surface;
d. one or more clips mounted to the plate body and configured to releasably hold a painting/drawing surface on the upper surface of the plate body; and
e. at least one attachment site on the plate body configured to receive at least one attachment in a pivoting fashion.

2. The portable art palette of claim 1, wherein the plate body comprises a top plate aligned atop a bottom plate, the top plate and the bottom plate having substantially the same footprint, and wherein the top plate includes a mixing tray opening, and wherein an exposed surface of the bottom plate through the mixing tray opening of the top plate provides the paint mixing surface bounded by edges of the mixing tray opening.

3. The portable art palette of claim 1, further comprising one or more magnets arranged below the upper surface of the plate body, the one or more magnets configured to hold a magnetically responsive item on the upper surface of the plate body.

4. The portable art palette of claim 2, further comprising one or more magnets arranged below the top plate, wherein the one or more magnets are positioned within one or more corresponding cutouts formed in the bottom plate, the one or more magnets configured to hold a magnetically responsive item on the upper surface of the plate body.

5. The portable art palette of claim 1, further comprising one or more elastic cords arranged on the upper surface of the plate body and secured thereto, the one or more elastic cords configured to hold any of an art utensil, a paper towel, or a sponge.

6. The portable art palette of claim 1, further comprising one or more openings disposed in the plate body, the one or more openings configurable to accommodate one or more art utensils comprising any one or more of a paint brush, a pencil, a marker, or an art utensil.

7. The portable art palette of claim 6, further comprising one or more slotted grommets mounted in the one or more openings of the plate body, the one or more slotted grommets configured to hold the one or more art utensils.

8. The portable art palette of claim 1, wherein the at least one attachment comprises one or more paddle attachments.

9. The portable art palette of claim 8, wherein the one or more paddle attachments comprise any one or more of a cup holder paddle having a cup-sized opening, a brush holder paddle having a plurality of circular openings of various diameters, or a mixing tray paddle having a recessed region for receiving and mixing paint.

10. The portable art palette of claim 9, wherein the one or more paddle attachments comprise a plurality of paddle attachments and are installed at a common attachment site in a stacked, pivoting arrangement.

11. The portable art palette of claim 1, further comprising a handle mounted on the lower surface of the plate body, the handle configured to be grasped by a user's hand.

12. The portable art palette of claim 11, wherein the handle is positioned at about a middle region of the lower surface of the plate body.

13. The portable art palette of claim 1, further comprising an elastic band spanning a lower portion of the plate body, the elastic band at least partially overlapping with the notch.

14. The portable art palette of claim 1, further comprising support arms spaced apart from one another and pivotally coupled to the lower surface of the plate body.

15. The portable art palette of claim 1, wherein the support arms are configurable to help support a painting/drawing surface or easel attachment attached to the plate body.

16. An easel attachment, the easel attachment comprising:
a. a support structure configured to support a painting/drawing surface;
b. a tripod plate mounted on an underside of the support structure, the tripod plate configured for mounting the easel attachment to a tripod;
c. at least one paddle attachment pivotally coupled to the support structure; and
d. wherein the support structure is configured to receive an art palette in a coupled arrangement.

17. The easel attachment of claim 16, further comprising an elastic cord arranged on the support structure, the elastic cord configured to hold down a lower edge of a painting surface positioned on the easel attachment.

18. The easel attachment of claim 16, wherein the at least one paddle attachment comprises one or more of a cup holder paddle having a cup-sized opening, a brush holder paddle having a plurality of circular openings of various diameters, or a mixing tray paddle having a recessed region for receiving and mixing paint.

19. The easel attachment of claim 16, wherein the at least one paddle attachment comprises a plurality of paddle attachments, wherein one or more of the plurality of paddle attachments are coupled to opposing sides of the support structure from another one or more of the plurality of paddle attachments.

20. The easel attachment of claim 16, wherein the support structure comprises a top plate aligned atop a bottom support.

21. The easel attachment of claim 16, wherein the support structure comprises a top plate, one or more support plates, and a bottom plate, wherein the one or more support plates are disposed between the top plate and the bottom plate.

22. A portable art palette system, comprising
a. an art palette, comprising
i. a plate body defining an upper surface and a lower surface;
ii. a notch formed along an edge of the plate body;
iii. a mixing tray region defined in a portion of the upper surface of the plate body, the mixing tray region providing a paint mixing surface;
iv. one or more clips mounted to the plate body and configured to releasably hold a painting/drawing surface on the upper surface of the plate body; and
v. at least one attachment site on the plate body configured to receive at least one paddle attachment in a pivoting fashion; and
b. an easel attachment configured to be coupled to the art palette, the easel attachment comprising:
i. a support structure configured to support a painting/drawing surface;
ii. a tripod plate mounted on an underside of the support structure, the tripod plate configured for mounting the easel attachment to a tripod; and
iii. at least one paddle attachment pivotally coupled to the support structure.
